(19) United States
(12) Patent Application Publication
(10) Pub. No.: US 2026/0020038 A1
(43) Pub. Date: Jan. 15, 2026

(54) USER EQUIPMENT CAPABILITY REPORTING ON SUPPORTED DOWNLINK REFERENCE TIMING VALUES

(71) Applicant: QUALCOMM Incorporated, San Diego, CA (US)

(72) Inventors: Shaozhen Guo, Beijing (CN); Mostafa Khoshnevisan, San Diego, CA (US); Jing Sun, San Diego, CA (US); Xiaoxia Zhang, San Diego, CA (US)

(21) Appl. No.: 18/881,895

(22) PCT Filed: Aug. 18, 2022
(86) PCT No.: PCT/CN2022/113278

§ 371 Date: Jan. 7, 2025

(51) Int. Cl. H04W 72/232; H04L 27/26; H04W 72/51

(52) U.S. Cl. CPC H04W 72/232; H04L 27/26025; H04W 72/51

(57) ABSTRACT

Techniques related to multiple downlink control information (multi-DCI) based multiple transmit/receive point (multi-TRP) communication are disclosed. Some aspects of the disclosure relate to devices and methods for user equipment (UE) capability information signaling. In some examples, a UE receives a control message configuring the UE for multi-DCI based multi-TRP communication. The UE transmits a UE capability information message relating to UE support for utilizing at least one of a single downlink reference timing value or plural downlink reference timing values. The UE then communicates with a serving cell with the single downlink reference timing value or with the multiple downlink reference timing values. Other aspects, embodiments, and features are also claimed and described.

### TECHNICAL FIELD

The technology discussed below relates generally to wireless communication systems, and more particularly, to user equipment (UE) capability information signaling.

### INTRODUCTION

As the demand for mobile broadband access continues to increase, research and development continue to advance wireless communication technologies not only to meet the growing demand for mobile broadband access, but to advance and enhance the user experience with mobile communications. For example, in multiple transmit/receive point (multi-TRP) operation, a serving cell schedules a wireless user equipment (UE) from two TRPs, providing better coverage, reliability, and/or data rates.

### BRIEF SUMMARY OF SOME EXAMPLES

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

Aspects of this disclosure are related to multiple downlink control information based multiple transmit/receive point (multi-DCI based multi-TRP) communication. In various aspects, the present disclosure provides capability signaling that user equipment (UE) can employ to notify a serving cell of its preferences and/or capabilities with respect to the use of a single downlink reference timing value or multiple downlink reference timing values when operating with multi-DCI based multi-TRP communication. In further aspects, the present disclosure provides capability signaling that a UE can employ to notify a serving cell of its preferences and/or capabilities with respect to the use of multiple downlink reference timing values that differ by greater than a threshold duration. In still further aspects, the present disclosure provides capability signaling that a UE can employ to notify a serving cell of its preferences and/or capabilities with respect to the use of a single fast Fourier transform (FFT) or multiple FFTs for DL reception when engaged in multi-DCI based multi-TRP communication. By virtue of these and other features disclosed herein, a UE may be enabled to achieve faster data rates, and a cell may be enabled to improve its capacity and spectral efficiency, when operating with multi-DCI based multi-TRP communication.

In one example, this disclosure describes a method of wireless communication that includes receiving a first control message configuring a user equipment (UE) for multiple downlink control information (multi-DCI) based multiple transmit/receive point (multi-TRP) communication corresponding to a plurality of TRPs; transmitting a first UE capability information message relating to UE support for utilizing at least one of a single downlink reference timing value corresponding to a first TRP of the plurality of TRPs, or multiple downlink reference timing values corresponding to the plurality of TRPs; and communicating with a serving cell with the single downlink reference timing value or with the multiple downlink reference timing values.

In another example, this disclosure describes a method of wireless communication that includes transmitting a first control message configuring a user equipment (UE) for multiple downlink control information (multi-DCI) based multiple transmit/receive point (multi-TRP) communication corresponding to a plurality of TRPs; receiving a first UE capability information message relating to UE support for utilizing at least one of a single downlink reference timing value corresponding to a first TRP of the plurality of TRPs, or multiple downlink reference timing values corresponding to the plurality of TRPs; and communicating with the UE with the single downlink reference timing value or with the multiple downlink reference timing values based on the first UE capability information message.

In another example, this disclosure describes an apparatus for wireless communication that includes a memory to store instructions; and a processor coupled to the memory and configured to execute the instructions including: receive a first control message configuring a user equipment (UE) for multiple downlink control information (multi-DCI) based multiple transmit/receive point (multi-TRP) communication corresponding to a plurality of TRPs; transmit a first UE capability information message relating to UE support for utilizing at least one of a single downlink reference timing value corresponding to a first TRP of the plurality of TRPs, or multiple downlink reference timing values corresponding to the plurality of TRPs; and communicate with a serving cell with the single downlink reference timing value or with the multiple downlink reference timing values.

In another example, this disclosure describes an apparatus for wireless communication that includes a memory to store instructions; and a processor coupled to the memory and configured to execute the instructions including transmit a first control message configuring a user equipment (UE) for multiple downlink control information (multi-DCI) based multiple transmit/receive point (multi-TRP) communication corresponding to a plurality of TRPs; receive a first UE capability information message relating to UE support for utilizing at least one of a single downlink reference timing value corresponding to a first TRP of the plurality of TRPs, or multiple downlink reference timing values corresponding to the plurality of TRPs; and communicate with the UE with the single downlink reference timing value or with the multiple downlink reference timing values based on the first UE capability information message. The details of one or more examples are set forth in the accompanying drawings and the description below. Other features, objects, and advantages will be apparent from the description, drawings, and claims.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a user equipment (UE) engaged in multiple-downlink control information (multi-DCI) based multiple transmit/receive point (multi-TRP) communication with a serving cell according to some aspects of this disclosure.

FIG. 2 is a schematic illustration of a wireless communication system according to some aspects of this disclosure.

FIG. 3 is a schematic illustration of an example of a radio access network according to some aspects of this disclosure.

FIG. 4 is a schematic illustration of an example of a disaggregated serving cell architecture according to some aspects of this disclosure.

FIG. 5 is a schematic illustration of a user plane protocol stack and a control plane protocol stack according to some aspects of this disclosure.

FIG. 6 is a schematic illustration of an organization of wireless resources in an air interface utilizing orthogonal frequency divisional multiplexing (OFDM) according to some aspects of this disclosure.

FIG. 7 is a block diagram conceptually illustrating an example of a hardware implementation for a serving cell according to some aspects of this disclosure.

FIG. 8 is a block diagram conceptually illustrating an example of a hardware implementation for a UE according to some aspects of this disclosure.

FIG. 9 is a schematic illustration of signal propagation delays and timing advance (TA) parameters according to some aspects of this disclosure.

FIG. 10 is a call flow diagram illustrating a UE engaged in multi-DCI based multi-TRP communication with a serving cell according to some aspects of this disclosure.

FIG. 11 is a flow chart illustrating an example of a process for multi-DCI based multi-TRP communication according to some aspects of this disclosure.

FIG. 12 is a flow chart illustrating another example of a process for multi-DCI based multi-TRP communication according to some aspects of this disclosure.

FIG. 13 is a flow chart illustrating another example of a process for multi-DCI based multi-TRP communication according to some aspects of this disclosure.

FIG. 14 is a flow chart illustrating another example of a process for multi-DCI based multi-TRP communication according to some aspects of this disclosure.

FIG. 15 is a flow chart illustrating another example of a process for multi-DCI based multi-TRP communication according to some aspects of this disclosure.

FIG. 16 is a flow chart illustrating another example of a process for multi-DCI based multi-TRP communication according to some aspects of this disclosure.

### DETAILED DESCRIPTION

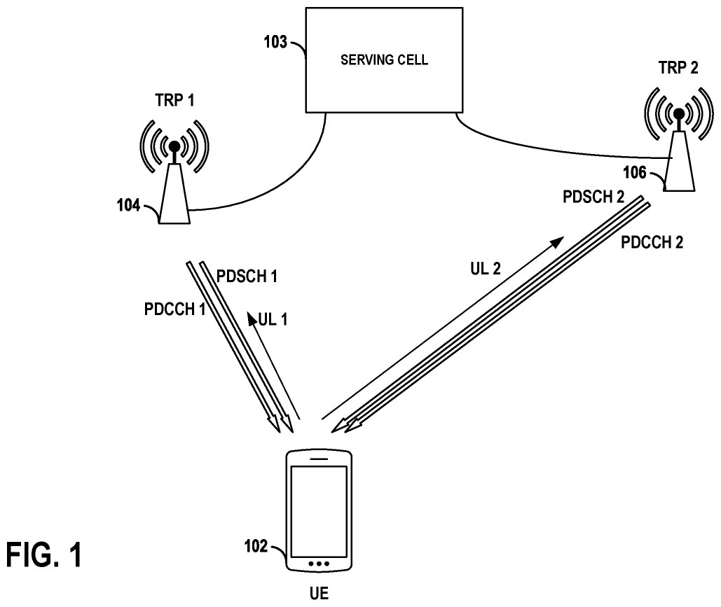

FIG. 1 is a schematic illustration of a user equipment (UE) 102 operating in multi-DCI based multi-TRP communication. In multiple transmit/receive point (multi-TRP) operation, a serving cell 103 schedules a UE 102 from two TRPs (104 and 106), providing better coverage, reliability, and/or data rates. Thus, for downlink communication (from the serving cell 103 to the UE 102), the UE 102 may receive multiple downlink transmissions (e.g., a physical downlink shared channel, or PDSCH) from different TRPs. Similarly, for uplink communication (from the UE 102 to the serving cell 103), the UE 102 may transmit multiple uplink transmissions (e.g., a physical uplink shared channel, or PUSCH) to different TRPs.

Although multiple TRPs may be configured for a serving cell, each TRP may be associated with the serving cell's physical cell ID (PCI) or an additional PCI different from the serving cell PCI. With multi-TRP operation, there are two potential configurations. In a first potential configuration (not illustrated), the different TRPs 104 and 106 may be different antennas or antenna panels that are collocated (e.g., at the same base station or gNB). In a second potential configuration (illustrated in FIG. 1), the different TRPs 104 and 106 may be non-collocated or located at different base stations or gNBs.

There are two different operation modes for a serving cell 103 to schedule multi-TRP PDSCH transmissions: single-downlink control information (single-DCI) and multi-DCI. In single-DCI mode (not illustrated), the UE 102 is scheduled by the same DCI for both TRPs. And in multi-DCI mode (illustrated in FIG. 1), the UE 102 is scheduled by independent DCIs from each TRP. Thus, as shown in FIG. 1, for multi-DCI based multi-TRP communication, for each PDSCH from a given TRP, that PDSCH is scheduled by a corresponding PDCCH from that TRP. That is, a first DCI (PDCCH1, transmitted from TRP1 104) schedules a first PDSCH (PDSCH1, transmitted from TRP1 104); and a second DCI (PDCCH2, transmitted from TRP2 106) schedules a second PDSCH (PDSCH2, transmitted from TRP2 106). Similarly, for each PUSCH the UE 102 transmits to a given TRP, that PUSCH is scheduled by a corresponding PDCCH from that TRP. That is, a first DCI (PDCCH1, transmitted from TRP1 104) schedules a first PUSCH (UL1, transmitted to TRP1 104); and a second DCI (PDCCH2, transmitted from TRP2 106) schedules a second PUSCH (UL2, transmitted to TRP2 106). In various aspects, the present disclosure relates to multi-DCI based multi-TRP communication.

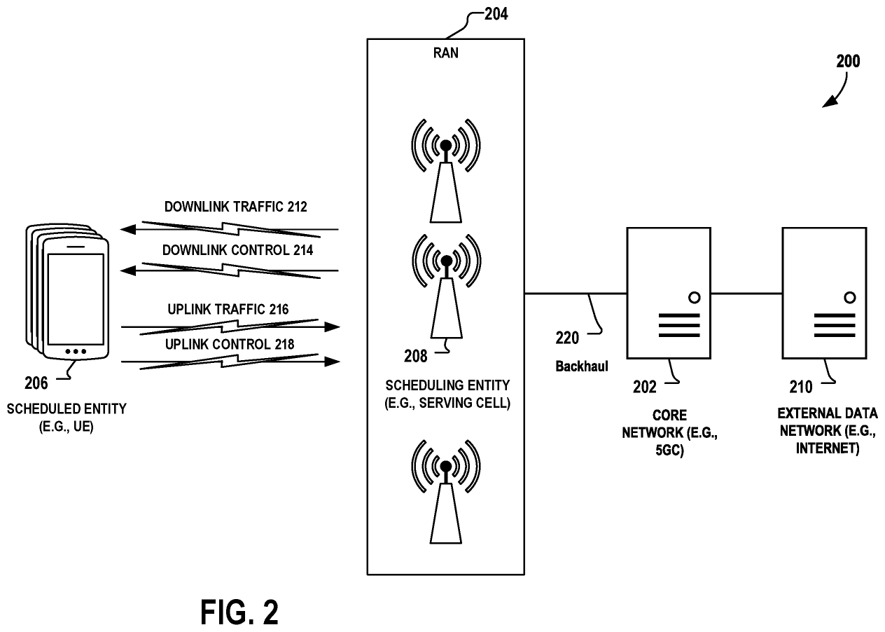

The disclosure that follows presents various techniques that may be implemented across a broad variety of telecommunication systems, network architectures, and communication standards. Referring now to FIG. 2, as an illustrative example without limitation, this schematic illustration shows various aspects of the present disclosure with reference to a wireless communication system 200. The wireless communication system 200 includes several interacting domains: a core network 202, a radio access network (RAN) 204, and a user equipment (UE) 206. The UE 206 may be the same as the UE 102 illustrated in FIG. 1. By virtue of the wireless communication system 200, the UE 206 may be enabled to carry out data communication with an external data network 210, such as (but not limited to) the Internet.

The RAN 204 may implement any suitable wireless communication technology or technologies to provide radio access to the UE 206. As one example, the RAN 204 may operate according to 3rd Generation Partnership Project (3GPP) New Radio (NR) specifications, often referred to as 5G or 5G NR. In some examples, the RAN 204 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 204 includes a plurality of base stations 208. A base station 208 may be the same as the serving cell 103 illustrated in FIG. 1. Broadly, a base station is a network element in a RAN 204 responsible for radio transmission and reception in one or more cells to or from a UE 206. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a serving cell, or some other suitable terminology. In some examples, a given base station or serving cell 208 may include any suitable number of one or more transmit/receive points (TRPs), as illustrated in FIG. 1.

The radio access network (RAN) 204 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move and may be stationary. The term mobile apparatus or mobile device broadly refers to a diverse array of devices and technologies. UEs 206 may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 204 and a UE 206 may be described as utilizing an air interface. Transmissions over the air interface from a base station (e.g., base station, serving cell, or network node 208) to one or more UEs (e.g., UE 206) may be referred to as downlink (DL) transmission. In accordance with certain aspects of the present disclosure, the term downlink may refer to a point-to-multipoint transmission originating at a serving cell (described further below; e.g., network node 208). Another way to describe this scheme may be to use the term broadcast channel multiplexing. Transmissions from a UE (e.g., UE 206) to a network node (e.g., serving cell 208) may be referred to as uplink (UL) transmissions. In accordance with further aspects of the present disclosure, the term uplink may refer to a point-to-point transmission originating at a scheduled entity (described further below; e.g., UE 206).

In some examples, access to the air interface may be scheduled, wherein a scheduling entity (e.g., a serving cell or network node 208) allocates resources for communication among some or all devices and equipment within its service area or cell. Within the present disclosure, as discussed further below, a scheduling entity, base station, network node, or serving cell may be responsible for scheduling, assigning, reconfiguring, and releasing resources for one or more scheduled entities. That is, for scheduled communication, UEs 206, which may be scheduled entities, may utilize resources allocated by a scheduling entity 208.

Base stations are not the only entities that may function as scheduling entities. That is, in some examples, a UE or network node may function as a scheduling entity, scheduling resources for one or more scheduled entities (e.g., one or more UEs).

As illustrated in FIG. 2, a serving cell 208 may broadcast downlink traffic 212 to one or more UEs 206. Broadly, the serving cell 208 is a node or device responsible for scheduling traffic in a wireless communication network, including downlink traffic 212 and, in some examples, uplink traffic 216 from one or more UEs 206 to the serving cell 208. On the other hand, the UE 206 is a node or device that receives downlink control information 214, including but not limited to scheduling information (e.g., a grant), synchronization or timing information, or other control information from another entity in the wireless communication network such as the serving cell 208.

In general, serving cells 208 may include a backhaul interface for communication with a backhaul portion 220 of the wireless communication system. The backhaul 220 may provide a link between a serving cell 208 and the core network 202. Further, in some examples, a backhaul network may provide interconnection between the respective serving cells 208. Various types of backhaul interfaces may be employed, such as a direct physical connection, a virtual network, or the like using any suitable transport network.

The core network 202 may be a part of the wireless communication system 200, and may be independent of the radio access technology used in the RAN 204. In some examples, the core network 202 may be configured according to 5G standards (e.g., 5GC). In other examples, the core network 202 may be configured according to a 4G evolved packet core (EPC), or any other suitable standard or configuration.

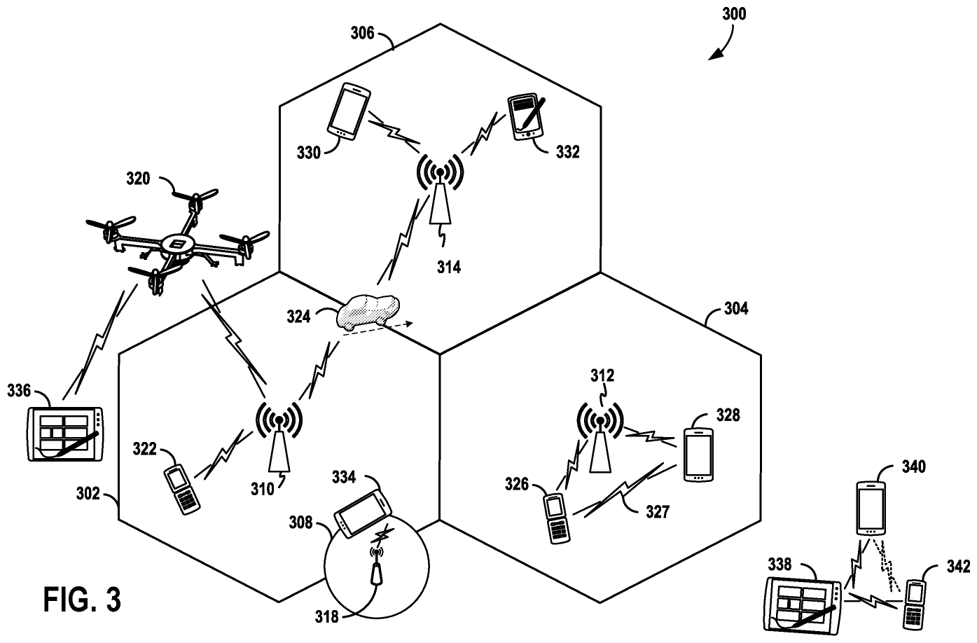

FIG. 3 provides a schematic illustration of a RAN 300, by way of example and without limitation. In some examples, the RAN 300 may be the same as the RAN 204 described above and illustrated in FIG. 2. The geographic area covered by the RAN 300 may be divided into cellular regions (cells) that a user equipment (UE) can uniquely identify based on an identification broadcasted from one serving cell, base station, or network node. FIG. 3 illustrates macrocells 302, 304, and 306, and a small cell 308.

FIG. 3 shows two three serving cells 310, and 312, and 314 in cells 302, 304, and 306. In the illustrated example, the cells 302, 304, and 306 may be referred to as macrocells, as the network nodes 310, 312, and 314 support cells having a large size. Further, a serving cell 318 is shown in the small cell 308 (e.g., a microcell, picocell, femtocell, home base station, home Node B, home eNode B, etc.) which may overlap with one or more macrocells. In this example, the cell 308 may be referred to as a small cell, as the serving cell 318 supports a cell having a relatively small size. Cell sizing can be done according to system design as well as component constraints.

The RAN 300 may include any number of wireless network nodes and cells. Further, a RAN may include a relay node to extend the size or coverage area of a given cell. The serving cells 310, 312, 314, 318 provide wireless access points to a core network for any number of mobile apparatuses. In some examples, the serving cells 310, 312, 314, and/or 318 may be the same as the base station/scheduling entity/serving cell 208 described above and illustrated in FIG. 2, and/or the serving cell 103 described above and illustrated in FIG. 1.

FIG. 3 further includes a quadcopter or drone 320, which may be configured to function as a serving cell. That is, in some examples, a cell may not necessarily be stationary, and the geographic area of the cell may move according to the location of a mobile serving cell such as the quadcopter 320.

Within the RAN 300, each serving cell 310, 312, 314, 318, and 320 may be configured to provide an access point to a core network 202 (see FIG. 2) for all the UEs in the respective cells. For example, UEs 322 and 324 may be in communication with serving cell 310; UEs 326 and 328 may be in communication with serving cell 312; UEs 330 and 332 may be in communication with serving cell 314; UE 334 may be in communication with serving cell 318; and UE 336 may be in communication with mobile serving cell 320. In some examples, the UEs 322, 324, 326, 328, 330, 332, 334, 336, 338, 340, and/or 342 may be the same as the UE/scheduled entity 206 described above and illustrated in FIG. 2, and/or the UE 102 described above and illustrated in FIG. 1.

In some examples, a mobile network node (e.g., quadcopter 320) may be configured to function as a UE. For example, the quadcopter 320 may operate within cell 302 by communicating with serving cell 310.

In a further aspect of the RAN 300, sidelink signals may be used between UEs without necessarily relying on scheduling or control information from a serving cell (e.g., a scheduling entity). For example, two or more UEs (e.g., UEs 326 and 328) may communicate with each other using peer to peer (P2P) or sidelink signals 327 without relaying that communication through a serving cell. In a further example, UE 338 is illustrated communicating with UEs 340 and 342. Here, the UE 338 may function as a scheduling entity or a primary sidelink device, and UEs 340 and 342 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 340 and 342 may optionally communicate directly with one another in addition to communicating with the serving cell 338. Thus, in a wireless communication system with scheduled access to time-frequency resources and having a cellular configuration, a P2P configuration, or a mesh configuration, a scheduling entity and one or more scheduled entities may communicate utilizing the scheduled resources.

The air interface in the radio access network 300 may utilize one or more multiplexing and multiple access algorithms to enable simultaneous communication of the various devices. For example, 5G NR specifications provide multiple access for UL transmissions from UEs 322 and 324 to the serving cell 310, and for multiplexing for DL transmissions from the serving cell 310 to one or more UEs 322 and 324, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a serving cell may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

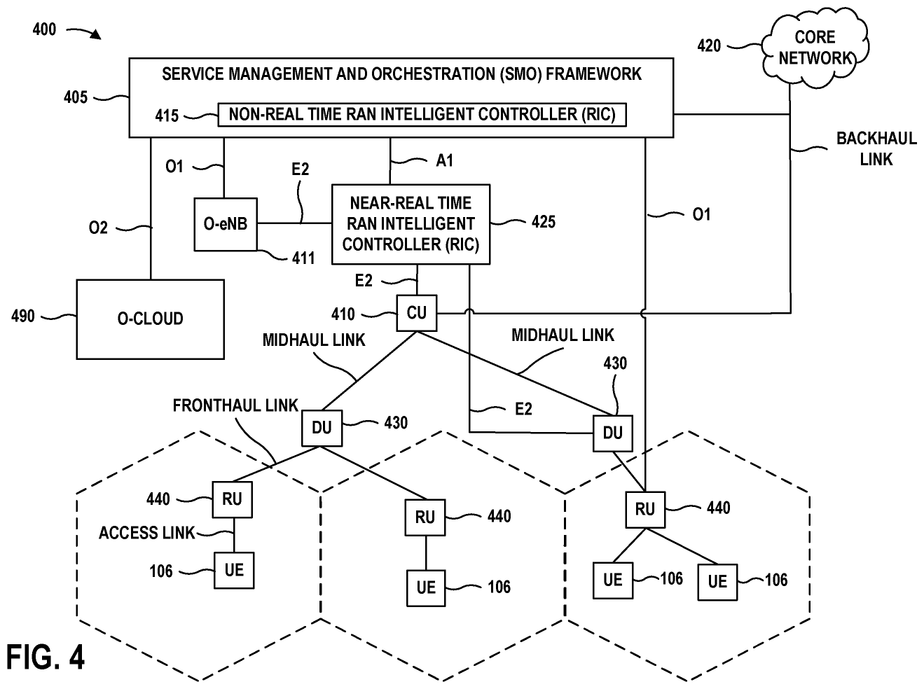

FIG. 4 shows a diagram illustrating an example disaggregated serving cell 400 architecture. The disaggregated serving cell 400 architecture may include one or more central units (CUs) 410 that can communicate directly with a core network 420 (e.g., the core network 202 described above and illustrated in FIG. 2) via a backhaul link, or indirectly with the core network 420 through one or more disaggregated serving cell units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 206 via one or more radio frequency (RF) access links. In some implementations, the UE 206 may be simultaneously served by multiple RUs 440. In some examples, a RU 440 may be the same as a TRP 104, 106 described above and illustrated in FIG. 1.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more serving cell functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440 (e.g., TRPs). In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 106. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

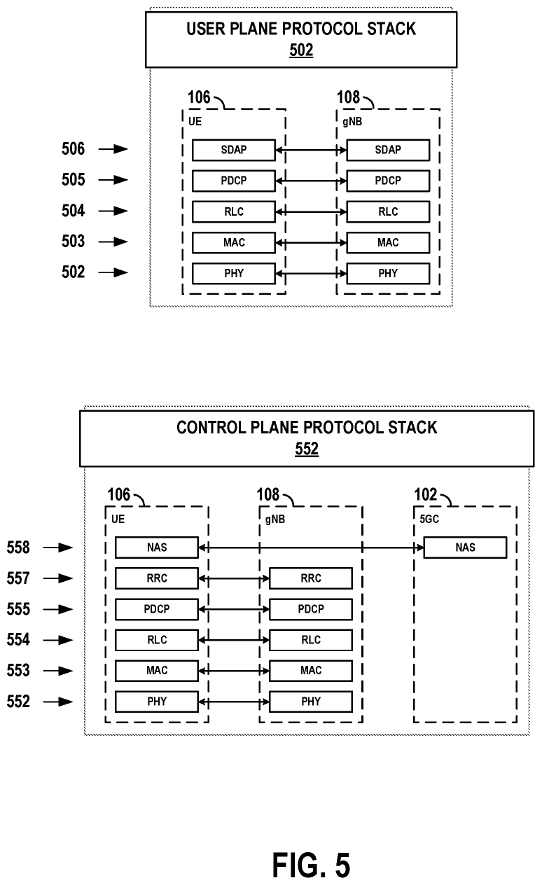

FIG. 5 is a schematic illustration of a user plane protocol stack 502 and a control plane protocol stack 552 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS, 558) and Access Stratum (AS, 502-506 and 552-557) layers and protocols. The NAS protocol 558 provides upper layers for signaling between a UE 206 and a core network 202 (referring to FIG. 2). The AS protocol 502-506 and 552-557 provides lower layers for signaling between the RAN 204 (e.g., a gNB or other serving cell 208) and the UE 206.

A radio protocol architecture is illustrated with a user plane protocol stack 502 and a control plane protocol stack 552, showing their respective layers or sublayers. Radio bearers between a network node 208 and a UE 206 may be categorized as data radio bearers (DRB) for carrying user plane data, corresponding to the user plane protocol 502; and signaling radio bearers (SRB) for carrying control plane data, corresponding to the control plane protocol 552.

In the AS, both the user plane 502 and control plane 552 protocols include a physical layer (PHY) 502/552, a medium access control layer (MAC) 503/553, a radio link control layer (RLC) 504/554, and a packet data convergence protocol layer (PDCP) 505/555. PHY 502/552 is the lowest layer and implements various physical layer signal processing functions. The MAC layer 503/553 provides multiplexing between logical and transport channels and is responsible for various functions. For example, the MAC layer 503/553 is responsible for reporting scheduling information, priority handling and prioritization, and error correction through hybrid automatic repeat request (HARQ) operations. The RLC layer 504/554 provides functions such as sequence numbering, segmentation and reassembly of upper layer data packets, and duplicate packet detection. The PDCP layer 505/555 provides functions including header compression for upper layer data packets to reduce radio transmission overhead, security by ciphering the data packets, and integrity protection and verification.

In the user plane protocol stack 502, a service data adaptation protocol (SDAP) layer 506 provides services and functions for maintaining a desired quality of service (QoS). And in the control plane protocol stack 552, a radio resource control (RRC) layer 557 includes a number of functional entities for routing higher layer messages, handling broadcasting and paging functions, establishing and configuring radio bearers, NAS message transfer between NAS and UE, etc.

A NAS protocol layer 558 provides for a wide variety of control functions between the UE 106 and core network 202. These functions include, for example, registration management functionality, connection management functionality, and user plane connection activation and deactivation.

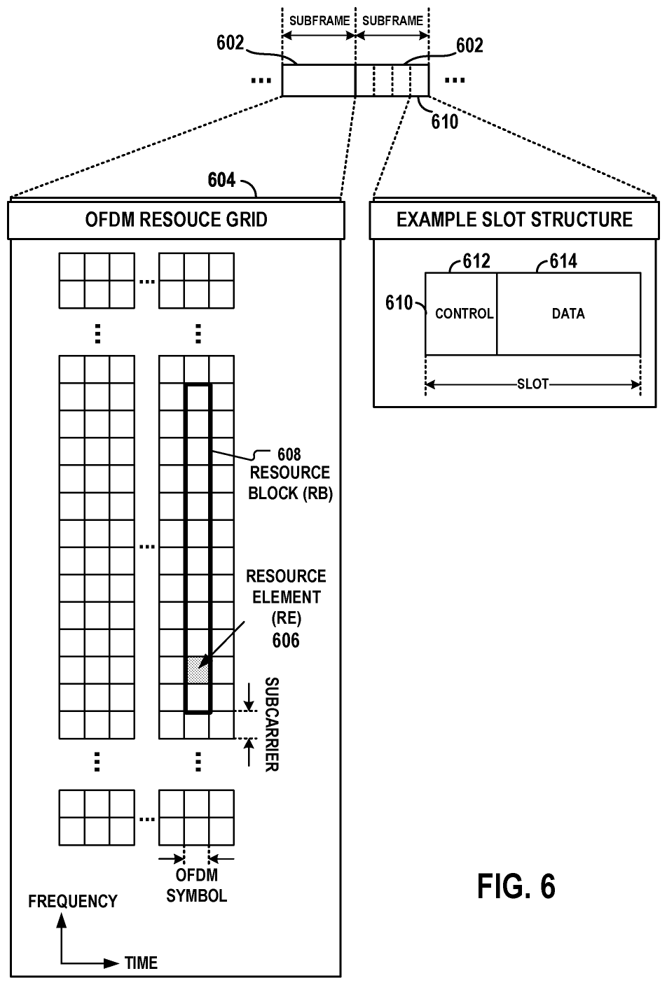

FIG. 6 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may include a set of subframes (e.g., 10 subframes of 1 ms each). A given carrier may include one set of frames in the UL, and another set of frames in the DL. FIG. 6 illustrates an expanded view of an exemplary DL subframe 602, showing an OFDM resource grid 604. However, as those skilled in the art will readily appreciate, the PHY transmission structure for any application may vary from the example described here, depending on any number of factors. Here, time is in the horizontal direction with units of OFDM symbols; and frequency is in the vertical direction with units of subcarriers or tones.

The resource grid 604 may schematically represent time-frequency resources for a given antenna port. That is, in a MIMO implementation with multiple antenna ports available, a corresponding multiple number of resource grids 604 may be available for communication. The resource grid 604 is divided into multiple resource elements (REs) 606. An RE, which is 1 subcarrier×1 symbol, is the smallest discrete part of the time-frequency grid and may contain a single complex value representing data from a physical channel or signal. Depending on the modulation utilized in a particular implementation, each RE may represent one or more bits of information, depending on the modulation used. In some examples, a block of REs may be referred to as a physical resource block (PRB) or more simply a resource block (RB) 608, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of the resource grid 604. An RB may be the smallest unit of resources that a scheduler can allocate to a UE. Thus, in general, the more RBs scheduled for a UE, and the higher the modulation scheme chosen for the air interface, the higher the data rate for the UE.

In this illustration, RB 608 occupies less than the entire bandwidth of the subframe 602, with some subcarriers illustrated above and below the RB 608. In a given implementation, subframe 602 may have a bandwidth corresponding to any number of one or more RBs 608. Further, the RB 608 is shown occupying less than the entire duration of the subframe 602, although this is merely one possible example.

Each 1 ms subframe 602 may include one or multiple adjacent slots. In FIG. 6, one subframe 602 includes four slots 610, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of the slots 610 illustrates the slot 610 including a control region 612 and a data region 614. In general, the control region 612 may carry control channels (e.g., PDCCH), and the data region 614 may carry data channels (e.g., PDSCH or PUSCH). Of course, a slot may contain all DL, all UL, or at least one DL portion and at least one UL portion. The structure illustrated in FIG. 6 is merely exemplary in nature, and different slot structures may be utilized, and may include one or more of each of the control region(s) and data region(s).

Although not illustrated in FIG. 6, the various REs 606 within an RB 608 may carry one or more physical channels, including control channels, shared channels, data channels, etc. Other REs 606 within the RB 608 may also carry pilots or reference signals. These pilots or reference signals may provide for a receiving device to perform channel estimation of the corresponding channel, which may enable coherent demodulation/detection of the control and/or data channels within the RB 608.

In a DL transmission, the transmitting device (e.g., a serving cell 103) may allocate one or more REs 606 (e.g., within a control region 612) to carry one or more DL control channels. These DL control channels include DL control information 114 (DCI) that generally carries information originating from higher layers, such as a physical broadcast channel (PBCH), a physical downlink control channel (PDCCH), etc., to one or more UEs 106. In addition, the serving cell may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A serving cell may transmit the synchronization signals PSS and SSS (collectively referred to as SS), and in some examples, the PBCH, in an SS block.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a UE 206) may utilize one or more REs 606 to carry one or more UL control channels, such as a physical uplink control channel (PUCCH), a physical random access channel (PRACH), etc. These UL control channels include UL control information 218 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 218 may include a scheduling request (SR), i.e., a request for the serving cell 103 to schedule uplink transmissions. Here, in response to the SR transmitted on the UL control channel 118 (e.g., a PUCCH), the serving cell 103 may transmit downlink control information (DCI) 214 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 606 (e.g., within the data region 614) may be allocated for user data or traffic data. Such traffic may be carried on one or more traffic channels, such as, for a DL transmission, a physical downlink shared channel (PDSCH); or for an UL transmission, a physical uplink shared channel (PUSCH).

Some modern wireless networks, such as a 5G NR network, may provide radio resources over a very wide frequency range. However, any given UE accessing a cell may have bandwidth capabilities that do not span this entire range. Accordingly, a serving cell 103 may configure a part or a portion of a carrier for that UE, called a bandwidth part (BWP), which has a bandwidth less than or equal to that UE's capabilities. A serving cell 103 may configure a UE with several BWPs (in some examples, up to four BWPs); although typically only a single BWP at a time is an active BWP. In this disclosure, a BWP refers to a set of wireless resources (e.g., a contiguous set of PRBs) selected as a subset of the wireless resources on a given carrier. In some examples, a BWP may be selected from among a contiguous set of resource blocks that share a common numerology (e.g., subcarrier spacing or SCS) on a given carrier. The serving cell 103 generally does not expect a UE to communicate outside an active BWP.

In order for a UE to gain initial access to a cell, the RAN may provide system information (SI) characterizing the cell. The RAN may provide this system information utilizing minimum system information (MSI), and other system information (OSI). The serving cell 103 may periodically broadcast the MSI over the cell to provide the most basic information a UE requires for initial cell access, and for enabling a UE to acquire any OSI that the RAN may broadcast periodically or send on-demand. In some examples, a serving cell may provide MSI over two different downlink channels. For example, the PBCH may carry a master information block (MIB), and the PDSCH may carry a system information block type 1 (SIB1). Here, the MIB may provide a UE with parameters for monitoring a control resource set (CORESET). The CORESET may thereby provide the UE with scheduling information corresponding to the PDSCH, e.g., a resource location of SIB1. In the art, SIB1 may be referred to as remaining minimum system information (RMSI).

The channels or carriers described above and illustrated in FIGS. 2 and 6 are not necessarily all the channels or carriers that may be utilized between a serving cell 103 and UE 102, and those of ordinary skill in the art will recognize that other channels or carriers may be utilized in addition to those illustrated, such as other traffic, control, and feedback channels.

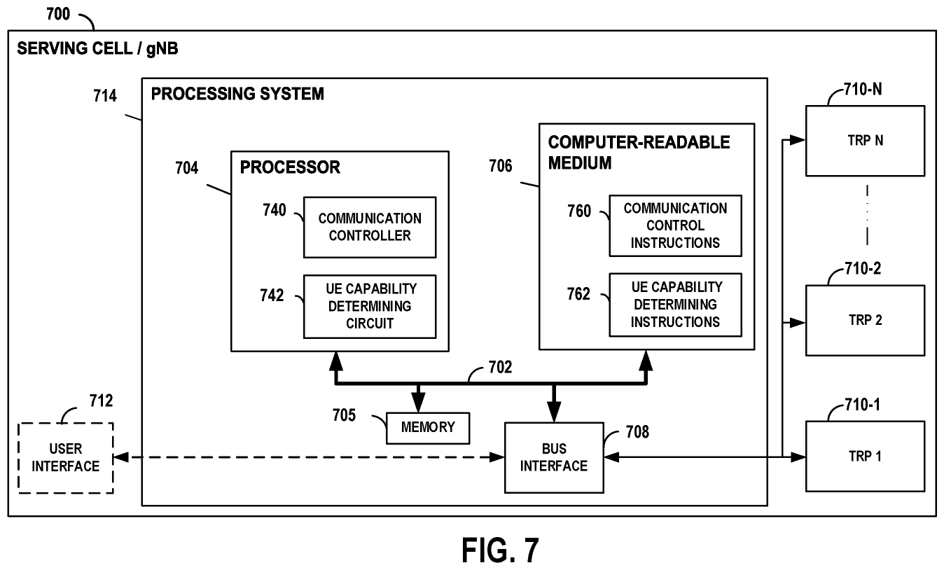

FIG. 7 is a block diagram illustrating an example of a hardware implementation for a serving cell 700 employing a processing system 714. For example, the serving cell 700 may be a user equipment (UE) as illustrated in any one or more of FIGS. 1, 2, and/or 3. In another example, the serving cell 700 may be a serving cell, base station, or gNB as illustrated in any one or more of FIGS. 1, 2, 3, and/or 4.

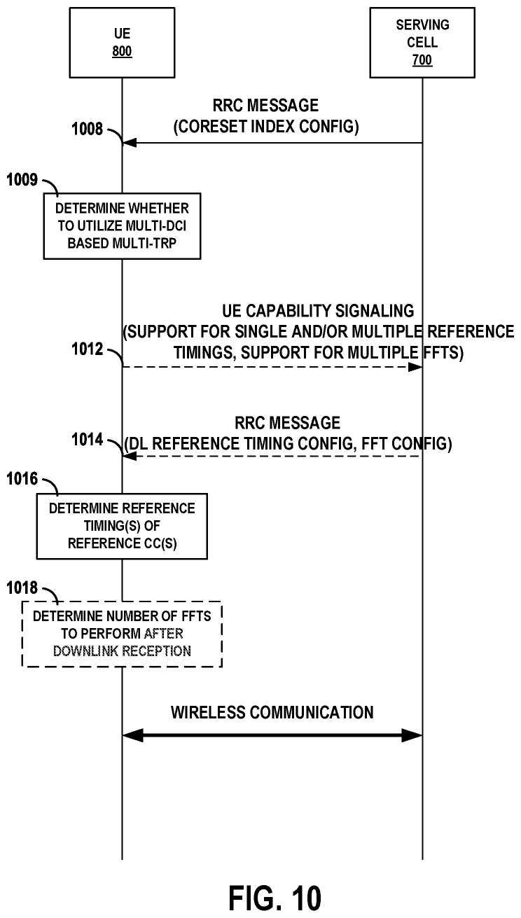

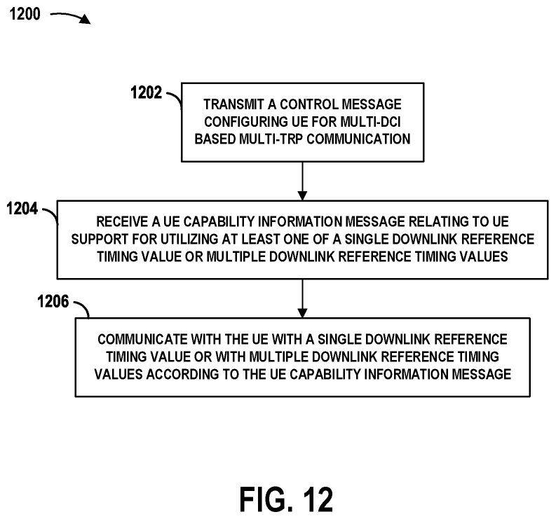

The serving cell 700 may include a processing system 714 having one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 700 may be configured to perform any one or more of the functions described herein. For example, the processor 704, as utilized in a serving cell 700, may be configured (e.g., in coordination with the memory 705) to implement any one or more of the processes and procedures described below and illustrated in FIGS. 10, 12, and/or 14.

The processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further. A bus interface 708 provides an interface between the bus 702 and a TRP 710. The TRP 710 provides a communication interface or means for communicating with various other apparatus over a transmission medium. Depending upon the nature of the apparatus, a user interface 712 (e.g., keypad, display, speaker, microphone, joystick) may also be provided. Of course, such a user interface 712 is optional, and some examples, such as a base station, may omit it.

In some aspects of the disclosure, the processor 704 may include a communication controller 740 configured (e.g., in coordination with the memory 705) for various functions, including, e.g., transmitting and/or receiving user data and/or control information to/from one or more UEs. For example, the communication controller 740 may be configured to implement one or more of the functions described below in relation to FIGS. 12 and/or 14.

In further aspects, the processor 704 may include a UE capability determining circuit 742 configured (e.g., in coordination with the memory 705) for various functions, including, e.g., determining a capability of a UE to support single and/or multiple downlink reference timing values, a capability of a UE to support performance of a single and/or multiple FFTs following downlink modulation, and/or any other UE capability. For example, the UE capability determining circuit 742 may be configured to implement one or more of the functions described below in relation to FIGS. 12 and/or 14.

The processor 704 is responsible for managing the bus 702 and general processing, including the execution of software stored on the computer-readable medium 706. The software, when executed by the processor 704, causes the processing system 714 to perform the various functions described below for any particular apparatus. The processor 704 may also use the computer-readable medium 706 and the memory 705 for storing data that the processor 704 manipulates when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 706 may store computer-executable code that includes communication control instructions 760 that configure a serving cell 700 for various functions, including, e.g., transmitting and/or receiving user data and/or control information to/from one or more UEs. For example, the communication control instructions 760 may be configured to cause a serving cell 700 to implement one or more of the functions described below in relation to FIGS. 12 and/or 14.

In further examples, the computer-readable storage medium 706 may store computer-executable code that includes UE capability determining instructions 762 that configure a serving cell 700 for various functions, including, e.g., determining a capability of a UE to support single and/or multiple downlink reference timing values, a capability of a UE to support performance of a single and/or multiple FFTs following downlink modulation, and/or any other UE capability. For example, the UE capability determining instructions 762 may be configured to cause a serving cell 700 to implement one or more of the functions described below in relation to FIGS. 12 and/or 14.

In one configuration, an apparatus 700 for wireless communication includes means for transmitting and/or receiving user data and/or control information to/from one or more UEs. In one aspect, the aforementioned means may be the processor(s) 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 3, and/or 4, and utilizing, for example, the processes and/or algorithms described herein in relation to FIGS. 12 and/or 14.

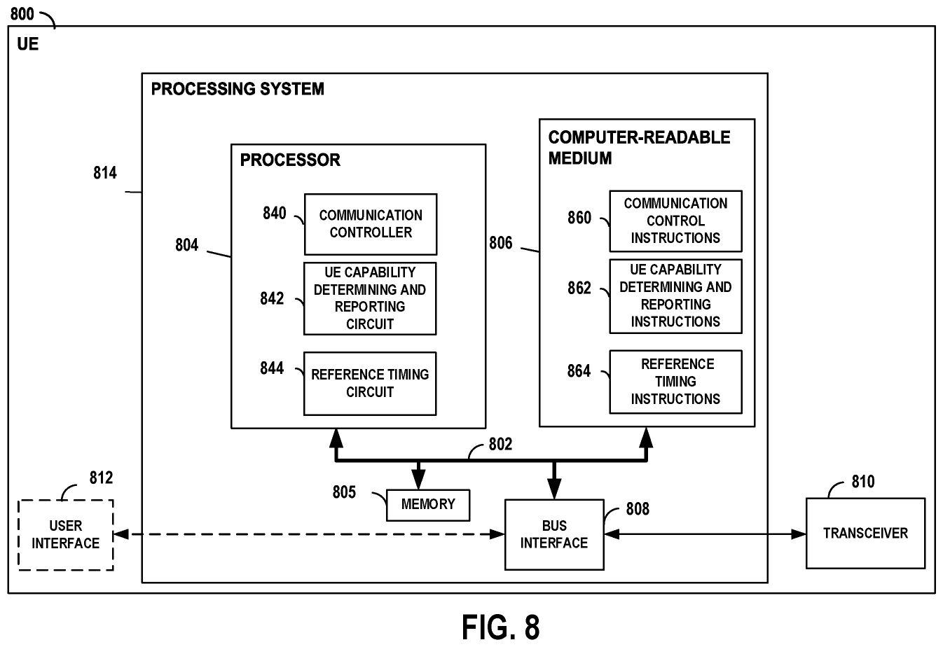

FIG. 8 is a conceptual diagram illustrating an example of a hardware implementation for an exemplary UE 800 employing a processing system 814. In accordance with various aspects of the disclosure, a processing system 814 may include an element, or any portion of an element, or any combination of elements having one or more processors 804. For example, the UE 800 may be a user equipment (UE) as illustrated in any one or more of FIGS. 1, 2, and/or 3.

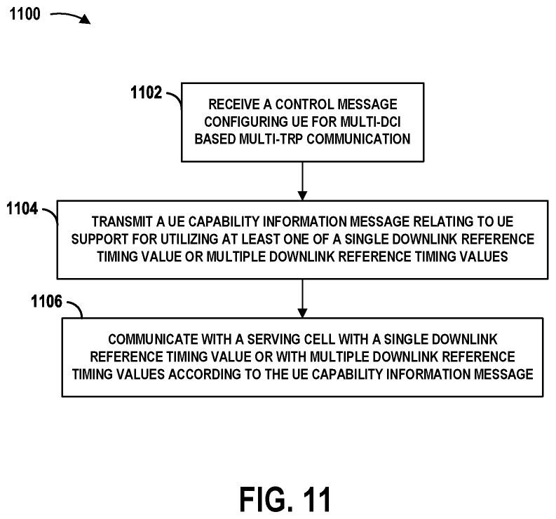

The processing system 814 may be substantially the same as the processing system 714 illustrated in FIG. 7, including a bus interface 808, a bus 802, memory 805, a processor 804, and a computer-readable medium 806. Furthermore, the UE 800 may include a user interface 812 and a transceiver 810 substantially similar to those described above in FIG. 7. That is, the processor 804, as utilized in a UE 800, may be configured (e.g., in coordination with the memory 805) to implement any one or more of the processes described below and illustrated in FIGS. 10, 11, and/or 13.

In some aspects of the disclosure, the processor 804 may include a communication controller 840 configured (e.g., in coordination with the memory 805) for various functions, including, e.g., transmitting and/or receiving user data and/or control information to/from one or more serving cells. For example, the communication controller 840 may be configured to implement one or more of the functions described below in relation to FIGS. 11 and/or 13.

In further aspects of the disclosure, the processor 804 may include a UE capability determining and reporting circuit 842 configured (e.g., in coordination with the memory 805) for various functions, including, e.g., determining and/or reporting a UE capability to support the utilization of a single and/or multiple downlink reference timing values corresponding to a plurality of TRPs, a UE capability to support multiple downlink reference timing values that differ by greater than a threshold duration, a UE capability to support the performance of a single and/or multiple FFTs following downlink demodulation, or any other suitable capability of the UE. For example, the UE capability determining and reporting circuit 842 may be configured to implement one or more of the functions described below in relation to FIGS. 11 and/or 13.

In still further aspects of the disclosure, the processor 804 may include a reference timing circuit 844 configured (e.g., in coordination with the memory 805) for various functions, including, e.g., identifying one or more suitable CCs (e.g., reference CCs) and determining one or more downlink reference timings for the reference CC(s) based on respective downlink reference signals from corresponding TRPs. For example, the reference timing circuit 844 may be configured to implement one or more of the functions described below in relation to FIGS. 11 and/or 13.

And further, the computer-readable storage medium 806 may store computer-executable code that includes communication control instructions 860 that configure a UE 800 for various functions, including, e.g., transmitting and/or receiving user data and/or control information to/from one or more serving cells. For example, the communication control instructions 860 may be configured to cause a UE 800 to implement one or more of the functions described below in relation to FIGS. 11 and/or 13.

In further aspects of the disclosure, the computer-readable storage medium 806 may store computer-executable code that includes UE capability determining and reporting instructions 862 that configure a UE 800 for various functions, including, e.g., determining and/or reporting a UE capability to support the utilization of a single and/or multiple downlink reference timing values corresponding to a plurality of TRPs, a UE capability to support multiple downlink reference timing values that differ by greater than a threshold duration, a UE capability to support the performance of a single and/or multiple FFTs following downlink demodulation, or any other suitable capability of the UE. For example, the UE capability determining and reporting instructions 862 may be configured to cause a UE 800 to implement one or more of the functions described below in relation to FIGS. 11 and/or 13.

In still further aspects of the disclosure, the computer-readable storage medium 806 may store computer-executable code that includes reference timing instructions 864 that configure a UE 800 for various functions, including, e.g., identifying one or more suitable CCs (e.g., reference CCs) and determining one or more downlink reference timings for the reference CC(s) based on respective downlink reference signals from corresponding TRPs. For example, the reference timing instructions 864 may be configured to cause a UE 800 to implement one or more of the functions described below in relation to FIGS. 11 and/or 13.

In one configuration, an apparatus 800 for wireless communication includes means for transmitting and/or receiving user data and/or control information to/from one or more serving cells, means for determining a number of FFTs to perform following downlink demodulation, and means for determining a reference timing of a reference CC. In one aspect, the aforementioned means may be the processor(s) 804 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, and/or 3, and utilizing, for example, the processes and/or algorithms described herein in relation to FIGS. 10, 11, and/or 13.

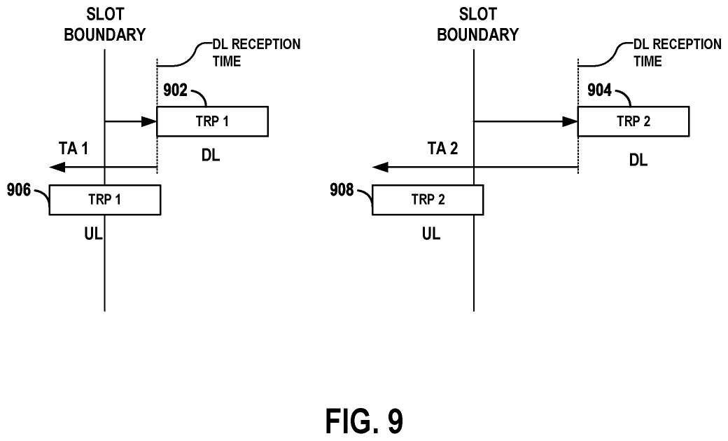

Referring once again to FIG. 1, with multi-DCI based multi-TRP communication, the signal propagation delay between the UE 102 and the different TRPs 104 and 106 may substantially differ when the respective TRPs are not collocated. For example, referring to FIG. 9, when a first TRP 104 (TRP1) transmits a first downlink (DL) slot 902 beginning at a given slot boundary, the UE 102 receives the first DL slot 902 at a later time; and if a second TRP 106 (TRP2) transmits a second DL slot 904 beginning at the same slot boundary, the UE 102 may receive the second DL slot 904 at a different time, e.g., based on a different propagation delay than that of the first DL slot 902. To compensate for this effect for uplink (UL) communication, a UE 102 may employ separate timing advance (TA) parameters for separate TRPs. TA is a parameter used for uplink communication. Here, to align UL slot boundaries according to the serving cell, the UE 102 transmits its UL transmissions a short time earlier than the timing of the serving cell. For example, when a UE 102 transmits a first UL slot 906 to a first TRP 104, it transmits the UL slot beginning at a time according to a first TA parameter TA 1 earlier than the slot boundary; and when the UE 102 transmits a second UL slot 908 to a second TRP 106, it transmits the UL slot beginning at a time according to a second TA parameter TA2 earlier than the slot boundary. In this way, due to the propagation delay of the UL transmissions, the slot boundaries substantially align at the receiving TRPs. The TA is a serving cell-configured parameter that determines how much earlier the UE transmits its uplink.

A TA is a relative value. That is, the TA is calculated relative to a reference timing (e.g., corresponding to the DL reception time in FIG. 9). Here, the timing of the downlink reception is utilized as the reference timing. In particular, a UE employs a downlink reference signal (RS) (e.g., CSI-RS, DM-RS, SS, or any other suitable RS) to determine the reference timing. This reference timing is not only utilized for alignment of uplink transmissions. In addition, a UE utilizes the downlink reference timing for alignment of slots in communication in the downlink direction.

When a UE 102 is engaged in multi-DCI based multi-TRP communication, as described above with reference to FIG. 1, if the UE 102 utilizes two TA values, the UE 102 may calculate both TAs relative to a single downlink reference timing (e.g., a downlink reference timing based on a reference CC transmitted by one of the TRPs). However, especially for non-collocated TRPs, the timing at the respective TRPs may not be synchronized. That is, slot boundaries according to one TRP 104 may be misaligned relative to slot boundaries at another TRP 106. Thus, in another example, if a UE 102 utilizes two TA values, the UE 102 may utilize two different downlink reference timing values. In some examples, two downlink reference timing values may be utilized independent of whether the respective TRPs are synchronized with one another. That is, even for synchronized and collocated TRPs, when engaged in multi-DCI based multi-TRP communication, a UE 103 may utilize two different downlink reference timing values.

However, not all UEs may have the capability to utilize multiple downlink reference timing values. That is, some UEs may have a capability only to utilize a single downlink reference timing value when utilizing multiple TAs in multi-DCI based multi-TRP communication. Moreover, a UE may be configured such that it is not preferable to utilize two different downlink reference timing values. This is because, if two downlink reference timing values differ from one another by greater than the duration of one cyclic prefix (CP), the UE may perform two fast Fourier transforms (FFTs) for downlink reception. Thus, even if a UE 102 is capable of utilizing two downlink reference timing values, as discussed further below, the UE 102 may signal to the serving cell 103 that UE 102 is only capable of utilizing a single downlink reference timing value, or that utilizing a single downlink reference timing value is preferable.

In various aspects, the present disclosure provides control signaling (e.g., UE capability signaling) that a UE 102 can employ to notify a serving cell 103 of its preferences and/or capabilities with respect to the use of a single downlink reference timing value or multiple downlink reference timing values. Based on such signaling, a serving cell 103 may configure multi-DCI based multi-TRP communication utilizing a single downlink reference timing value or multiple downlink reference timing values.

FIG. 10 is a call flow diagram illustrating a UE 800 in communication with a serving cell 700, utilizing multi-DCI based multi-TRP communication with multiple TA values. In various examples, the UE 800 may correspond to any of the UEs described above and illustrated in FIGS. 1, 2, 3, 4, and/or 8. Further, the serving cell 700 may correspond to any of the serving cells, base stations, or gNBs described above and illustrated in FIGS. 1, 2, 3, 4, and/or 7.

With multi-DCI based multi-TRP communication, the UE 800 differentiates one TRP from another based on the value of the parameter (′ORESETPoolIndex, which is part of the higher layer parameter PDC (′H-Config. That is, a serving cell 700 may transmit RRC signaling 1008 for configuring different CORESETs with different values of CORESETPoolIndex. Each CORESET (from among a maximum of 5 CORESETs) can be configured with a value of CORESETPoolIndex. The value of CORESETPoolIndex may be 0 or 1. This groups or pools the CORESETs in to two groups or pools. Other than the differentiation according to (′ORESETPoolIndex, “different TRPs” is transparent to the UE 800.

At block 1009, a UE 800 may determine whether it is configured for multi-DCI based multi-TRP communication in a given component carrier (CC) based on the value(s) of CORESETPoolIndex in the higher layer parameter PD (CH-Config corresponding to that CC. That is, if a UE 800 is configured with two different values for CORESETPoolIndex (e.g., 0 and 1) for different CORESETs in the active BWP of a serving cell, then multi-DCI based multi-TRP communication is enabled or configured for that UE 800.

As described below, in various aspects of this disclosure, when a given UE 800 is configured for multi-DCI based multi-TRP communication, the UE 800 may or may not have a capability to support multiple downlink reference timing values, and/or may or may not have a capability to support the performance of multiple FFTs for DL reception from the respective TRPs.

For example, according to one aspect of this disclosure, a UE 800 may have a default mode where it supports only a single downlink reference timing value. Here, if it is preferable for the UE 800 to utilize a plurality of different downlink reference timing values (e.g., for multiple TAs in multi-DCI based multi-TRP communication), and the UE 800 has the capability to do so, the UE 800 may transmit UE capability signaling 1012 indicating its support for multiple downlink reference timing values. That is, the UE capability signaling 1012 may include a parameter that indicates the UE's support for multiple downlink reference timing values, or may omit such a parameter if the UE 800 prefers to remain in its default mode where it supports only a single downlink reference timing value.

In another example, a UE 800 may transmit UE capability signaling 1012 that indicates whether the UE 800 supports a single downlink reference timing value, or multiple downlink reference timing values. Here, as one nonlimiting example, the UE capability signaling 1012 may include a binary value, where a value of 0 indicates that the UE 800 supports a single downlink reference timing value, and a value of 1 indicates that the UE 800 supports multiple downlink reference timing values.

In still another example, a UE 800 may transmit UE capability signaling 1012 that indicates whether the UE 800 supports a single downlink reference timing value only, whether the UE 800 supports multiple downlink reference timing values only, or whether the UE 800 supports both a single and multiple downlink reference timing value(s). In this manner, the serving cell 700 and the UE 800 may have greater flexibility with respect to the use of one or multiple downlink reference timing values. Here, the UE 800 may transmit UE capability signaling 1012 with a first value indicating support of a single reference timing value only, with a second value indicating support of multiple reference timing values only, or with a third value indicating support of both a single downlink reference timing value and multiple downlink reference timing values. In this example, if the UE 800 indicates support of both a single and multiple downlink reference timing values, the serving cell 700 may respond with suitable control signaling to configure the UE 800 to utilize either a single reference timing value or multiple reference timing values. As one nonlimiting example, the serving cell 700 may transmit an RRC configuration message 1014 that configures the UE 800 to utilize either a single downlink reference timing value or multiple downlink reference timing values.

In various aspects of this disclosure, as for the UE capability signaling 1012 that indicates support for single and/or multiple downlink reference timing values when utilizing multi-DCI based multi-TRP communication with multiple TA values for different TRPs, this UE capability signaling 1012 may have any suitable granularity. For example, the UE capability signaling 1012 may indicate a capability to support single and/or multiple downlink reference timing values per UE. That is, there may be a single indication for such UE capability across bands, SCSes, etc.

In another example, for a given UE, that UE may have different capabilities to support single and/or multiple downlink reference timing values for different bands (e.g., different support for frequency range 1 (FR1) vs. frequency range 2 (FR2)), or for different band combinations. Accordingly, a UE 800 may separately report (e.g., utilizing the UE capability signaling 1012 described above) its support for single and/or multiple downlink reference timing values per band, or per band combination. If the UE reports the UE capability per band combination, then the UE capability may differentiate between FR1 and FR2. And in a case where a UE 800 reports its support for both single and multiple downlink reference timing values for a given band or band combination, in response, a serving cell 700 may transmit a control message (e.g., the RRC message 1014) to the UE 800 configuring the UE 800 for a single downlink reference timing value, or for multiple downlink reference timing values, per cell group, per CC of a band, or per BWP of a CC.

In another example, for a given UE, that UE 800 may have different support for single and/or multiple downlink reference timing values for different feature sets (FS) (e.g., for different bands of a band combination). Accordingly, a UE 800 may report (e.g., utilizing the UE capability signaling 1012 described above) its support for single and/or multiple downlink reference timing values per band of a band combination. And thus, in a case where a UE 800 reports its support for both single and multiple downlink reference timing values for a given band of a band combination, a serving cell 700 may transmit a control message (e.g., the RRC message 1014) to the UE 800 configuring the UE 800 for a single downlink reference timing value, or for multiple downlink reference timing values, per cell group, per CC of a band, or per BWP of a CC.

And in another example, for a given UE, that UE 800 may have different capabilities to support single and/or multiple downlink reference timing values for different feature sets per component carrier (FSPC) (e.g., for different CCs of a band of a band combination). Accordingly, a UE 800 may report (e.g., utilizing the UE capability signaling 1012 described above) different support for single and/or multiple downlink reference timing values per CC per band of a band combination. And thus, in a case where a UE 800 reports its support for both single and multiple downlink reference timing values for a given CC of a band of a band combination, a serving cell 700 may transmit a control message (e.g., the RRC message 1014) to the UE 800 configuring the UE 800 for a single downlink reference timing value, or for multiple downlink reference timing values, per cell group, per CC of a band, or per BWP of a CC.

And in still another example, for a given UE, that UE 800 may have different capabilities to support single and/or multiple downlink reference timing values for different subcarrier spacing (SCS) values. Accordingly, a UE 800 may report (e.g., utilizing the UE capability signaling 1012 described above) different support for single and/or multiple downlink reference timing values per SCS. And thus, in a case where a UE 800 reports its support for both single and multiple downlink reference timing values for a given SCS, a serving cell may transmit a control message (e.g., the RRC message 1014) to the UE configuring the UE for a single downlink reference timing value, or for multiple downlink reference timing values, per cell group, per CC of a band, or per BWP of a CC.

At block 1016, the UE 800 may determine the downlink reference timing value(s) to be utilized. For example, if a single downlink reference timing value is configured, the UE 800 may identify a suitable CC (e.g., a reference CC) and may determine a single downlink reference timing for the reference CC. In another example, if multiple downlink reference timing values are configured, the UE 800 may determine each of the multiple downlink reference timing values based on respective downlink signals from corresponding TRPs.

As introduced above, when a UE 800 employs multiple downlink reference timing values for a given CC, the number of FFTs that a UE 800 performs after DL reception may be affected by the magnitude of the difference in the respective downlink reference timing values. For example, where two different downlink reference timing values are used (in particular, when the difference between downlink reference timing values for two TRPs is greater than the duration of a cyclic prefix (CP)), a UE 800 may be required to perform two FFTs for downlink reception. Meanwhile, if the difference between downlink reference timing values for two TRPs is less than the duration of a CP, a single FFT following reception of a downlink communication may be sufficient.

Accordingly, in some examples, the difference between downlink reference timing values for multiple given TRPs may have a predetermined maximum value corresponding to the duration of a CP. For example, specifications for 5G NR (or any other suitable communication standard) may specify such a maximum difference between downlink reference timing values for multiple TRPs as a suitable predetermined value, such as the duration of a CP. In this manner, a UE 800 may assume that performing a single FFT following reception of a downlink communication will suffice, and the UE 800 need not necessarily maintain the capability of performing two FFTs following downlink reception when utilizing multi-DCI based multi-TRP communication with two TAs and two different downlink reference timing values.

However, in other examples, the performance of multiple FFTs may be within a UE's capability. In some instances, for a UE 800 with such a capability, the benefits of using separate downlink reference timing values with a large difference (e.g., greater than a CP duration) may outweigh the costs of performing multiple FFTs after the downlink reception. Thus, in a further aspect of the present disclosure, a UE 800 may employ UE capability signaling 1012 to notify a serving cell 700 of its capability to use multiple downlink reference timing values whose difference is greater than a threshold duration (e.g., the duration of a CP).

For example, according to an aspect of this disclosure, a UE 800 may have a default mode where the difference between downlink reference timing values for different TRPs is assumed to be within (e.g., less than) the duration of a CP. If the UE 800 prefers or is capable to utilize a plurality of downlink reference timing values with a large timing difference (e.g., a difference greater than the duration of a CP), the UE 800 may transmit UE capability signaling 1012 indicating its support for a large timing difference between multiple downlink reference timing values. That is, UE capability signaling 1012 may include a parameter that indicates its support for a large difference in timing among multiple downlink reference timing values, or may omit such a parameter if the UE 800 prefers to remain in its default mode where it assumes that a difference in timing among multiple downlink reference timing values is small (e.g., less than the duration of a CP).

In another example, a UE 800 may transmit UE capability signaling 1012 that indicates whether or not the UE 800 supports multiple downlink reference timing values with a large difference (e.g., greater than the duration of a CP). Here, as one nonlimiting example, the UE capability signaling 1012 may include a binary value, where a value of 0 indicates that the UE 800 will assume that a difference in timing among multiple downlink reference timing values is small (e.g., less than the duration of a CP). And a value of 1 indicates support for a large difference in timing among multiple downlink reference timing values (e.g., greater than the duration of a CP).

In the above examples, if a UE 800 indicates support of a large (e.g., greater than the duration of a CP) difference in downlink reference timing values for different TRPs, then at block 1018 the UE 800 may then determine a number of FFTs to employ after DL reception. The determination may be based on the configured downlink reference timing values, signaling from the serving cell 700 (e.g., RRC message 1014), and/or any other suitable parameters.

According to some aspects of this disclosure, the UE 800 may determine independently of the serving cell 700 how many FFTs it will perform after downlink reception. That is, a given UE may have freedom to determine, on its own (e.g., based on whether or not the difference in downlink reference timing values for different TRPs is greater than the duration of a CP and/or on any other suitable factors or parameters), how many FFTs to employ following downlink reception.

In some other aspects of this disclosure, the serving cell 700 may determine whether a UE 800 is to employ a single FFT or multiple FFTs after downlink reception. For instance, the serving cell 700 may determine how many FFTs a UE 800 is to employ based on the duration of a difference in downlink reference timing values for different TRPs. In some examples, the serving cell may signal to the UE 800, utilizing any suitable control signaling (including but not limited to an RRC message 1014) an instruction whether to use a single FFT or to use multiple FFTs after downlink reception.

In still other aspects of this disclosure, rather than dictating the number of FFTs for a UE 800 to employ, a serving cell 700 may signal to the UE, utilizing any suitable control signaling (including but not limited to an RRC message 1014), an indication of whether the UE 800 can assume that the downlink reference timing values for multiple TRPs have a large difference (e.g., greater than a suitable threshold duration such as the duration of a CP). In this example, a UE 800 may determine, e.g., based on this control signaling 1014 (and in some examples, based on any other additional factors or parameters), the number of FFTs to employ after downlink reception.

In various aspects of this disclosure, when a UE 800 reports its capability relating to support for multiple FFTs, this capability may have any suitable granularity or specificity as to such support. For example, the UE capability signaling 1012 may indicate a UE capability as a whole, whether the UE can support multiple FFTs after downlink reception. In another example, the UE capability signaling 1012 may indicate a UE's support for multiple FFTs after downlink reception per band. That is, in some examples, a UE 800 may report that it supports multiple FFTs for one band while it does not support multiple FFTs for another band. For example, a UE may report different capabilities of support for multiple FFTs between FR1 and FR2 operation. In another example, the UE capability signaling 1012 may indicate a UE's support for multiple FFTs after downlink reception per band combination, per feature set (FS, e.g., per band of a band combination), per feature set per CC (FSPC, e.g., per CC of a band of a band combination), or per SCS. In case the UE capability is per UE or per band combination, the UE capability may differentiate between FR1 and FR2, so that the UE may report different capability between FR1 and FR2.

FIG. 11 is a flow chart illustrating an exemplary process 1100 for multi-DCI based multi-TRP communication in accordance with some aspects of the present disclosure. As described below, a particular implementation may omit some or all illustrated features, and may not require some illustrated features to implement all embodiments. In some examples, the UE 800 illustrated in FIG. 8 may be configured to carry out the process 1100. In some examples, any suitable apparatus or means for carrying out the functions or algorithm described below may carry out the process 1100.

At block 1102, a UE 800 may receive (e.g., utilizing a transceiver 810) a control message configuring the UE 800 for multi-DCI based multi-TRP communication. For example, as described above, the UE 800 may receive an RRC message that configures at least two different values for the parameter CORESETPoolIndex for different CORESETs in the active BWP of a serving cell 700. In some examples, the communication controller 840 corresponding to the processor 804 may determine whether the UE 800 is configured for multi-DCI based multi-TRP communication.

At block 1104, the UE 800 may transmit (e.g., utilizing the transceiver 810) a UE capability information message relating to UE support for utilizing at least one of a single downlink reference timing value, or multiple downlink reference timing values. For example, a UE capability determining and reporting circuit 842 corresponding to the processor 804 may determine a UE capability relating to support for a single and/or multiple downlink reference timing values, and may cause the transceiver 810 to transmit a corresponding UE capability information message. In various examples, the UE capability information message may indicate support for multiple downlink reference timing values, may indicate a lack of support for multiple downlink reference timing values, or may indicate support for both a single and for multiple downlink reference timing values. Further, in various examples, the UE capability, and the corresponding UE capability information message, may be a capability for the UE as a whole, or may differ per band, per band combination, per FS, per FSPC, and/or per SCS.

At block 1106, the UE 800 may communicate (e.g., utilizing the transceiver 810) with a serving cell 700 with a single downlink reference timing value or with multiple downlink reference timing values, according to the UE capability information message transmitted at block 1104. For example, the communication controller 840 corresponding to the processor 804 may cause the transceiver 810 to communicate with the serving cell 700 according to the UE capability information message transmitted at block 1104.

FIG. 12 is a flow chart illustrating an exemplary process 1200 for multi-DCI based multi-TRP communication in accordance with some aspects of the present disclosure. As described below, a particular implementation may omit some or all illustrated features, and may not require some illustrated features to implement all embodiments. In some examples, the serving cell 700 illustrated in FIG. 7 may be configured to carry out the process 1200. In some examples, any suitable apparatus or means for carrying out the functions or algorithm described below may carry out the process 1200.

At block 1202, a serving cell 700 may transmit (e.g., utilizing at least one of the TRPs 710) a control message configuring a UE 800 for multi-DCI based multi-TRP communication. For example, as described above, the serving cell 700 may transmit an RRC message that configures at least two different values for the parameter CORESETPoolIndex for different CORESETs in the active BWP of the serving cell 700. In some examples, the communication controller 740 corresponding to the processor 704 may determine whether to configure the UE 800 for multi-DCI based multi-TRP communication.

At block 1204, the serving cell 700 may receive (e.g., utilizing at least one of the TRPs 710) a UE capability information message relating to UE support for at least one of a single downlink reference timing value, or multiple downlink reference timing values. For example, the communication controller 740 corresponding to the processor 704 may receive the UE capability information message and may accordingly determine UE support for a single downlink reference timing value, for multiple downlink reference timing values, or both.

At block 1206, the serving cell 700 may communicate (e.g., utilizing a plurality of the TRPs 710) with the UE 800 with a single downlink reference timing value or with multiple downlink reference timing values, according to the UE capability information message received at block 1204. For example, the communication controller 740 corresponding to the processor 704 may cause the TRPs 710 to communicate with the UE 800 according to the UE capability information message received at block 1204.

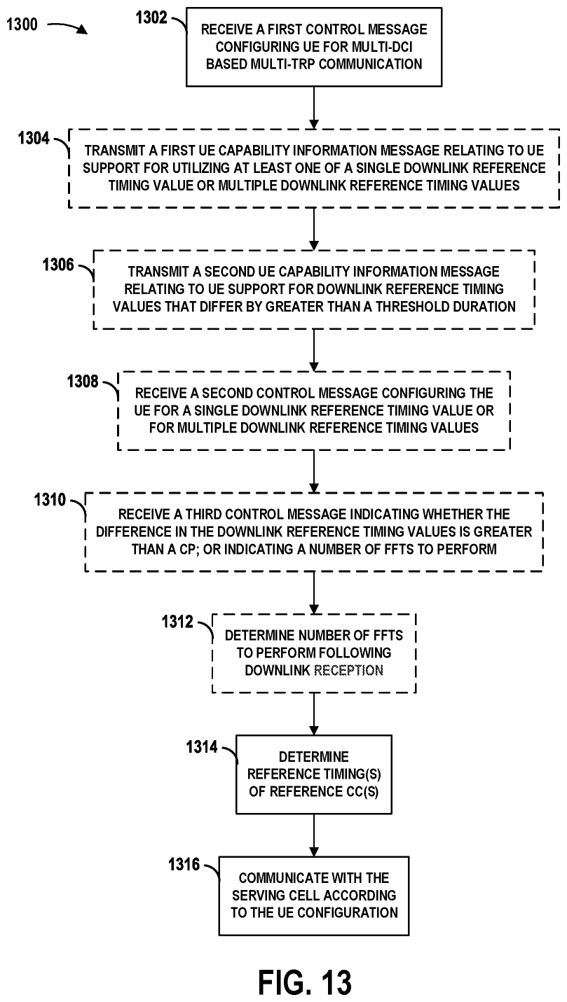

FIG. 13 is a flow chart illustrating an exemplary process 1300 for multi-DCI based multi-TRP communication in accordance with some aspects of the present disclosure. As described below, a particular implementation may omit some or all illustrated features, and may not require some illustrated features to implement all embodiments. In some examples, the UE 800 illustrated in FIG. 8 may be configured to carry out the process 1100. In some examples, any suitable apparatus or means for carrying out the functions or algorithm described below may carry out the process 1300.

At block 1302, a UE 800 may receive (e.g., utilizing a transceiver 810) a first control message configuring the UE 800 for multi-DCI based multi-TRP communication. For example, as described above, the UE 800 may receive a first RRC message that configures at least two different values for the parameter CORESETPoolIndex for different CORESETs in the active BWP of a serving cell 700. In some examples, the communication controller 840 corresponding to the processor 804 may determine whether the UE 800 is configured for multi-DCI based multi-TRP communication.

At optional block 1304, the UE 800 may transmit (e.g., utilizing the transceiver 810) a first UE capability information message relating to UE support for utilizing at least one of a single downlink reference timing value, or multiple downlink reference timing values. For example, a UE capability determining and reporting circuit 842 corresponding to the processor 804 may determine a UE capability relating to support for a single and/or multiple downlink reference timing values, and may cause the transceiver 810 to transmit a corresponding UE capability information message. In various examples, the first UE capability information message may indicate support for multiple downlink reference timing values, may indicate a lack of support for multiple downlink reference timing values, or may indicate support for both a single and for multiple downlink reference timing values. Further, in various examples, the UE capability, and the corresponding first UE capability information message, may be a capability for the UE as a whole, or may differ per band, per band combination, per FS, per FSPC, and/or per SCS.

At optional block 1306, the UE 800 may transmit (e.g., utilizing the transceiver 810) a second UE capability information message relating to UE support for a downlink reference timing difference of greater than a threshold duration. For example, a UE capability determining and reporting circuit 842 corresponding to the processor 804 may determine a UE capability relating to support for a downlink reference timing difference of greater than a threshold duration, and may cause the transceiver 810 to transmit a corresponding UE capability information message. In various examples, the second UE capability information message may indicate support for a downlink reference timing difference greater than a threshold duration, may indicate a lack of support for a downlink reference timing difference greater than a threshold duration, or may indicate support for both a downlink reference timing difference greater than and less than a threshold duration. Further, in various examples, the UE capability, and the corresponding second UE capability information message, may be a capability for the UE as a whole, or may differ per band, per band combination, per FS, per FSPC, and/or per SCS.

At optional block 1308, the UE 800 may receive (e.g., utilizing the transceiver 810) a second control message configuring the UE 800 for a single downlink reference timing value or for multiple downlink reference timing values. For example, in a case where the second UE capability information message of block 1306 indicates support for both a single downlink reference timing value and multiple downlink reference timing values per UE, per band, per band combination, per FS, per FSPC, and/or per SCS, then the second control message may configure the UE 800 for a single downlink reference timing value or for multiple downlink reference timing values per UE, per cell group, per CC of a band, or per BWP of a CC. In some examples, the UE capability determining and reporting circuit 842 may configure the communication controller 840 according to the second control message.

In some examples, at optional block 1310, the UE 800 may receive (e.g., utilizing the transceiver 810) a third control message indicating whether the difference in the downlink reference timing values is greater than a threshold duration (e.g., the duration of a CP). In other examples, at optional block 1310, the UE 800 may receive (e.g., utilizing the transceiver 810) a third control message indicating a number of FFTs for the UE 800 to perform after downlink reception. For example, the communication controller 840 corresponding to the processor 804 may receive the third control message via the transceiver 810.

At optional block 1312, the UE 800 may determine the number of FFTs to perform after downlink reception. For example, if the difference between downlink reference timing values for multiple TRPs has a predetermined maximum value (e.g., a value corresponding to the duration of a CP), the communication controller 840 corresponding to the processor 804 may determine to utilize a single FFT after downlink reception. In another example, the communication controller 840 corresponding to the processor 804 may determine to operate in a default mode, utilizing a single FFT after downlink reception. In still another example, the communication controller 840 corresponding to the processor 804 may determine whether to utilize a single FFT or multiple FFTs after downlink reception based at least in part on the third control message of block 1310. For example, where the third control message of block 1310 indicates that the difference in the downlink reference timing values is less than a threshold duration (e.g., the duration of a CP), the UE 800 may determine to utilize a single FFT after downlink reception; and where the third control message of block 1310 indicates that the difference in the downlink reference timing values is greater than a threshold duration (e.g., the duration of a CP), the UE 800 may determine to utilize multiple FFTs after downlink reception. In another example, where the third control message of block 1310 indicates a number of FFTs for the UE 800 to perform, the UE 800 may determine the number of FFTs to perform based on the indication of the third control message.

At block 1314, the UE 800 may determine the downlink reference timing value(s) to be utilized. For example, as described above, if a single downlink reference timing value is configured, the reference timing circuit 844 corresponding to the processor 804 may identify a suitable CC (e.g., a reference CC) and may determine a single downlink reference timing for the reference CC. And in another example, if multiple downlink reference timing values are configured, the reference timing circuit 844 corresponding to the processor 804 may determine each of the multiple downlink reference timing values based on respective downlink reference signals from corresponding TRPs.

At block 1316, the UE 800 may communicate (e.g., utilizing the transceiver 810) with a serving cell 700 based on the downlink reference timing difference across different TRPs or CORESETPoolIndex values. For example, the communication controller 840 corresponding to the processor 804 may cause the transceiver 810 to communicate with the serving cell 700 according to the first and/or second UE capability information messages transmitted at blocks 1304 and 1306, and/or according to the first, second, and/or third control messages received at blocks 1302, 1308, and/or 1310.

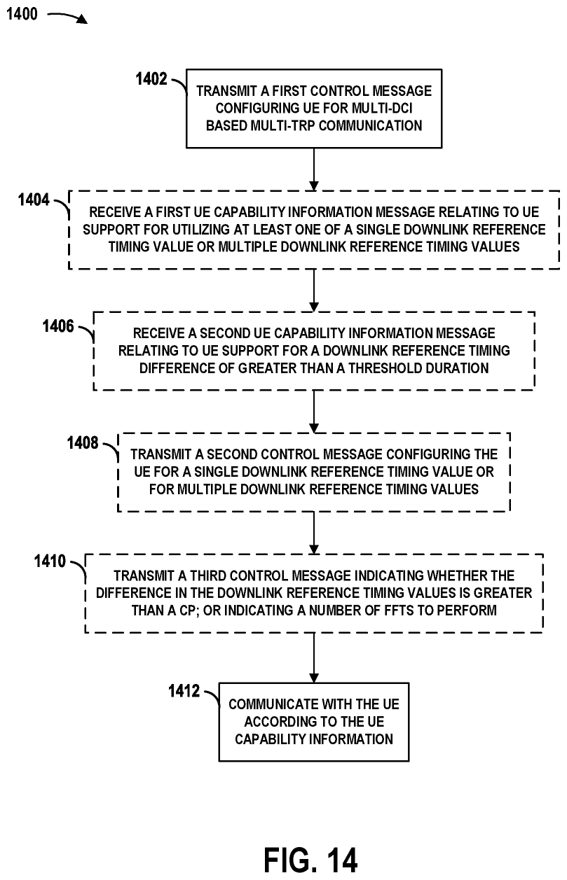

FIG. 14 is a flow chart illustrating an exemplary process 1400 for multi-DCI based multi-TRP communication in accordance with some aspects of the present disclosure. As described below, a particular implementation may omit some or all illustrated features, and may not require some illustrated features to implement all embodiments. In some examples, the serving cell 700 illustrated in FIG. 7 may be configured to carry out the process 1100. In some examples, any suitable apparatus or means for carrying out the functions or algorithm described below may carry out the process 1400.

At block 1402, a serving cell 700 may transmit (e.g., utilizing a transceiver 710) a first control message configuring a UE 800 for multi-DCI based multi-TRP communication. For example, as described above, the serving cell 700 may transmit a first RRC message that configures at least two different values for the parameter CORESETPoolIndex for different CORESETs in the active BWP of the serving cell 700. In some examples, the communication controller 740 corresponding to the processor 704 may determine whether the serving cell 700 configures the UE 800 for multi-DCI based multi-TRP communication.

At optional block 1404, the serving cell 700 may receive (e.g., utilizing one or more of the TRPs 710) a first UE capability information message relating to UE support for utilizing at least one of a single downlink reference timing value, or multiple downlink reference timing values. For example, the communication controller 740 corresponding to the processor 704 may receive the first UE capability information message and may accordingly determine the UE's capability relating to support for a single and/or multiple downlink reference timing values. In various examples, the first UE capability information message may indicate support for multiple downlink reference timing values, may indicate a lack of support for multiple downlink reference timing values, or may indicate support for both a single and for multiple downlink reference timing values. Further, in various examples, the UE capability, and the corresponding first UE capability information message, may be a capability for the UE as a whole, or may differ per band, per band combination, per FS, per FSPC, and/or per SCS.

At optional block 1406, the serving cell 700 may receive (e.g., utilizing one or more of the TRPs 710) a second UE capability information message relating to UE support for a downlink reference timing difference of greater than a threshold duration. For example, the communication controller 740 corresponding to the processor 704 may receive the second UE capability information message and may accordingly determine the UE's capability relating to support for a downlink reference timing difference of greater than a threshold duration. In various examples, the second UE capability information message may indicate support for a downlink reference timing difference greater than a threshold duration, may indicate a lack of support for a downlink reference timing difference greater than a threshold duration, or may indicate support for both a downlink reference timing difference greater than and less than a threshold duration. Further, in various examples, the UE capability, and the corresponding second UE capability information message, may be a capability for the UE as a whole, or may differ per band, per band combination, per FS, per FSPC, and/or per SCS.

At optional block 1408, the serving cell 700 may transmit (e.g., utilizing one or more of the TRPs 710) a second control message configuring the UE 800 for a single downlink reference timing value or for multiple downlink reference timing values. For example, in a case where the second UE capability information message of block 1406 indicates support for both a single downlink reference timing value and multiple downlink reference timing values per UE, per band, per band combination, per FS, per FSPC, and/or per SCS, then the UE capability determining circuit 742 may configure the second control message and cause one or more of the TRPs 710 to transmit the second control message to configure the UE 800 for a single downlink reference timing value or for multiple downlink reference timing values per UE, per cell group, per CC of a band, or per BWP of a CC.

In some examples, at optional block 1410, the serving cell 700 may transmit (e.g., utilizing one or more of the TRPs 710) a third control message indicating whether the difference in the downlink reference timing values is greater than a threshold duration (e.g., the duration of a CP). In other examples, at optional block 1410, the serving cell 700 may transmit (e.g., utilizing one or more of the TRPs 710) a third control message indicating a number of FFTs for the UE 800 to perform after downlink reception. For example, the communication controller 740 corresponding to the processor 704 may transmit the third control message via one or more of the TRPs 710.

At block 1412, the serving cell 700 may communicate (e.g., utilizing a plurality of the TRPs 710) with the UE 800 based on the downlink reference timing differences across different TRPs or CORESETPoolIndex values. For example, the communication controller 740 corresponding to the processor 704 may cause the TRPs 710 to communicate with the UE 800 according to the first and/or second UE capability information messages received at blocks 1404 and 1406, and/or according to the first, second, and/or third control messages transmitted at blocks 1402, 1408, and/or 1410.

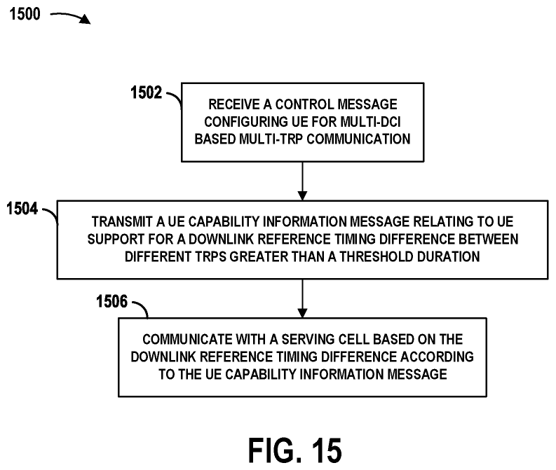

FIG. 15 is a flow chart illustrating an exemplary process 1500 for multi-DCI based multi-TRP communication in accordance with some aspects of the present disclosure. As described below, a particular implementation may omit some or all illustrated features, and may not require some illustrated features to implement all embodiments. In some examples, the UE 800 illustrated in FIG. 8 may be configured to carry out the process 1500. In some examples, any suitable apparatus or means for carrying out the functions or algorithm described below may carry out the process 1500.

At block 1502, a UE 800 may receive (e.g., utilizing a transceiver 810) a control message configuring the UE 800 for multi-DCI based multi-TRP communication. For example, as described above, the UE 800 may receive an RRC message that configures at least two different values for the parameter CORESETPoolIndex for different CORESETs in the active BWP of a serving cell 700. In some examples, the communication controller 840 corresponding to the processor 804 may determine whether the UE 800 is configured for multi-DCI based multi-TRP communication.

At block 1504, the UE 800 may transmit (e.g., utilizing the transceiver 810) a UE capability information message relating to UE support for a downlink reference timing difference of greater than a threshold duration. For example, a UE capability determining and reporting circuit 842 corresponding to the processor 804 may determine a UE capability relating to support for a downlink reference timing difference of greater than a threshold duration, and may cause the transceiver 810 to transmit a corresponding UE capability information message. In various examples, the UE capability information message may indicate support for a downlink reference timing difference greater than a threshold duration, may indicate a lack of support for a downlink reference timing difference greater than a threshold duration, or may indicate support for both a downlink reference timing difference greater than and less than a threshold duration. Further, in various examples, the UE capability, and the corresponding UE capability information message, may be a capability for the UE as a whole, or may differ per band, per band combination, per FS, per FSPC, and/or per SCS.

At block 1506, the UE 800 may communicate (e.g., utilizing the transceiver 810) with a serving cell 700 based on the downlink reference timing difference according to the UE capability information message transmitted at block 1504. For example, the communication controller 840 corresponding to the processor 804 may cause the transceiver 810 to communicate with the serving cell 700 according to the UE capability information message transmitted at block 1504.

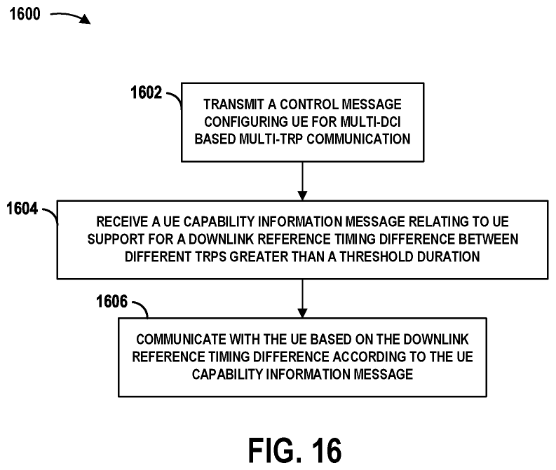

FIG. 16 is a flow chart illustrating an exemplary process 1600 for multi-DCI based multi-TRP communication in accordance with some aspects of the present disclosure. As described below, a particular implementation may omit some or all illustrated features, and may not require some illustrated features to implement all embodiments. In some examples, the UE 800 illustrated in FIG. 8 may be configured to carry out the process 1600. In some examples, any suitable apparatus or means for carrying out the functions or algorithm described below may carry out the process 1600.

At block 1602, a serving cell 700 may transmit (e.g., utilizing at least one of the TRPs 710) a control message configuring a UE 800 for multi-DCI based multi-TRP communication. For example, as described above, the serving cell 700 may transmit an RRC message that configures at least two different values for the parameter CORESETPoolIndex for different CORESETs in the active BWP of the serving cell 700. In some examples, the communication controller 740 corresponding to the processor 704 may determine whether to configure the UE 800 for multi-DCI based multi-TRP communication.

At block 1604, the serving cell 700 may receive (e.g., utilizing one or more of the TRPs 710) a UE capability information message relating to UE support for a downlink reference timing difference of greater than a threshold duration. For example, the communication controller 740 corresponding to the processor 704 may receive the UE capability information message and may accordingly determine the UE's capability relating to support for a downlink reference timing difference of greater than a threshold duration. In various examples, the UE capability information message may indicate support for a downlink reference timing difference greater than a threshold duration, may indicate a lack of support for a downlink reference timing difference greater than a threshold duration, or may indicate support for both a downlink reference timing difference greater than and less than a threshold duration. Further, in various examples, the UE capability, and the corresponding UE capability information message, may be a capability for the UE as a whole, or may differ per band, per band combination, per FS, per FSPC, and/or per SCS.

At block 1606, the serving cell 700 may communicate (e.g., utilizing a plurality of the TRPs 710) with the UE 800 based on the downlink reference timing difference according to the UE capability information message received at block 1604. For example, the communication controller 740 corresponding to the processor 704 may cause the TRPs 710 to communicate with the UE 800 according to the UE capability information message received at block 1604.

### Further Examples Having a Variety of Features

Clause 1: A method of wireless communication includes receiving a first control message configuring a user equipment (UE) for multiple downlink control information (multi-DCI) based multiple transmit/receive point (multi-TRP) communication corresponding to a plurality of TRPs; transmitting a first UE capability information message relating to UE support for utilizing at least one of a single downlink reference timing value corresponding to a first TRP of the plurality of TRPs, or multiple downlink reference timing values corresponding to the plurality of TRPs; and communicating with a serving cell with the single downlink reference timing value or with the multiple downlink reference timing values.

Clause 2: The method of clause 1, wherein the first control message configures the UE with multiple control resource set pool index ((′ORESETPoolIndex) values on a serving cell.

Clause 3: The method of any of clauses 1 and 2, wherein the first UE capability information message indicates support for single and/or multiple downlink reference timing values: per UE; per band; per band combination; per feature set (FS); per feature set per component carrier (FSPC); or per subcarrier spacing (SCS).

Clause 4: The method of any of clauses 1 through 3, wherein the first UE capability information message indicates support for both the single downlink reference timing value and the multiple downlink reference timing values.

Clause 5: The method of clause 4, further includes receiving a second control message configuring the UE for one of the single downlink reference timing value or the multiple downlink reference timing values.

Clause 6: The method of clause 5, wherein the second control message configures the UE: per cell group; per component carrier (CC); or per bandwidth part (BWP) of a CC.

Clause 7: The method of any of clauses 1 through 6, further includes transmitting a second UE capability information message relating to support for one of a downlink reference timing difference between different TRPs of the plurality of TRPs within a threshold duration, or a downlink reference timing difference between different TRPs of the plurality of TRPs greater than a threshold duration.

Clause 8: The method of clause 7, wherein the second UE capability information message indicates support for one of the downlink reference timing difference within the threshold duration or the downlink reference timing difference greater than the threshold duration: per UE; per band; per band combination; per feature set (FS); per feature set per component carrier (FSPC); or per subcarrier spacing (SCS).

Clause 9: The method of any of clauses 7 and 8, wherein the threshold duration is the duration of an orthogonal frequency division multiplexing (OFDM) cyclic prefix (CP).

Clause 10: The method of any of clauses 7 through 9, further includes determining a number of fast Fourier transforms (FFTs) to perform after downlink reception.

Clause 11: The method of clause 10, wherein determining the number of FFTs to perform is based on a downlink reference timing difference between different TRPs of the plurality of TRPs.

Clause 12: The method of clause 11, further comprising receiving a third control message indicating whether the difference in the downlink reference timing values is greater than the threshold duration.

Clause 13: The method of any of clauses 10 through 12, further comprising receiving a third control message indicating a number of FFTs to perform, wherein determining the number of FFTs to perform is based on the third control message.

Clause 14: A method of wireless communication includes transmitting a first control message configuring a user equipment (UE) for multiple downlink control information (multi-DCI) based multiple transmit/receive point (multi-TRP) communication corresponding to a plurality of TRPs; receiving a first UE capability information message relating to UE support for utilizing at least one of a single downlink reference timing value corresponding to a first TRP of the plurality of TRPs, or multiple downlink reference timing values corresponding to the plurality of TRPs; and communicating with the UE with the single downlink reference timing value or with the multiple downlink reference timing values based on the first UE capability information message.

Clause 15: The method of clause 14, wherein the first control message configures the UE with multiple control resource set pool index ((′ORESETPoolIndex) values on a serving cell.

Clause 16: The method of any of clauses 14 and 15, wherein the first UE capability information message indicates support for single and/or multiple downlink reference timing values: per UE; per band; per band combination; per feature set (FS); per feature set per component carrier (FSPC); or per subcarrier spacing (SCS).

Clause 17: The method of any of clauses 14 through 16, wherein the first UE capability information message indicates support for both the single downlink reference timing value and the plural downlink reference timing values.

Clause 18: The method of any of clauses 14 through 17, further includes transmitting, in response to the first UE capability information message, a second control message configuring the UE for one of the single downlink reference timing value or the multiple downlink reference timing values.

Clause 19: The method of clause 18, wherein the second control message configures the UE: per cell group; per component carrier (CC); or per bandwidth part (BWP) of a CC.

Clause 20: The method of any of clauses 14 through 19, further includes receiving a second UE capability information message relating to support for a downlink reference timing difference between different TRPs of the plurality of TRPs greater than a threshold duration.

Clause 21: The method of clause 20, wherein the second UE capability information message indicates support for one of downlink reference timing difference within the threshold duration or the downlink reference timing difference greater than the threshold duration: per UE; per band; per band combination; per feature set (FS); per feature set per component carrier (FSPC); or per subcarrier spacing (SCS).

Clause 22: The method of any of clauses 20 and 21, wherein the threshold duration is the duration of an orthogonal frequency division multiplexing (OFDM) cyclic prefix (CP).

Clause 23: The method of any of clauses 20 through 22, further comprising transmitting a third control message indicating whether the difference in the downlink reference timing values is greater than the threshold duration.

Clause 24: An apparatus for wireless communication includes a memory to store instructions; and a processor coupled to the memory and configured to execute the instructions including receive a first control message configuring a user equipment (UE) for multiple downlink control information (multi-DCI) based multiple transmit/receive point (multi-TRP) communication corresponding to a plurality of TRPs; transmit a first UE capability information message relating to UE support for utilizing at least one of a single downlink reference timing value corresponding to a first TRP of the plurality of TRPs, or multiple downlink reference timing values corresponding to the plurality of TRPs; and communicate with a serving cell with the single downlink reference timing value or with the multiple downlink reference timing values.

Clause 25: The apparatus of clause 24, wherein the first UE capability information message indicates support for both the single downlink reference timing value and the multiple downlink reference timing values.

Clause 26: The apparatus of clause 25, further includes receiving a second control message configuring the UE for one of the single downlink reference timing value or the multiple downlink reference timing values.

Clause 27: The apparatus of any of clauses 24 through 26, wherein the instructions further comprise code for causing the apparatus to: transmit a second UE capability information message relating to support for one of a downlink reference timing difference between different TRPs of the plurality of TRPs within a threshold duration, or a downlink reference timing difference between different TRPs of the plurality of TRPs greater than a threshold duration.

Clause 28: The apparatus of clause 27, wherein the instructions further comprise code for causing the apparatus to: determine a number of fast Fourier transforms (FFTs) to perform after downlink reception.

Clause 29: The apparatus of clause 28, wherein the code for causing the apparatus to determine the number of FFTs to perform is based on a downlink reference timing difference between different TRPs of the plurality of TRPs.

Clause 30: An apparatus for wireless communication includes a memory to store instructions; and a processor coupled to the memory and configured to execute the instructions including transmit a first control message configuring a user equipment (UE) for multiple downlink control information (multi-DCI) based multiple transmit/receive point (multi-TRP) communication corresponding to a plurality of TRPs; receive a first UE capability information message relating to UE support for utilizing at least one of a single downlink reference timing value corresponding to a first TRP of the plurality of TRPs, or multiple downlink reference timing values corresponding to the plurality of TRPs; and communicate with the UE with the single downlink reference timing value or with the multiple downlink reference timing values based on the first UE capability information message.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication, comprising:
receiving a first control message configuring a user equipment (UE) for multiple downlink control information (multi-DCI) based multiple transmit/receive point (multi-TRP) communication corresponding to a plurality of TRPs;
transmitting a first UE capability information message relating to UE support for utilizing at least one of a single downlink reference timing value corresponding to a first TRP of the plurality of TRPs, or multiple downlink reference timing values corresponding to the plurality of TRPs; and
communicating with a serving cell with the single downlink reference timing value or with the multiple downlink reference timing values.

2. The method of claim 1, wherein the first control message configures the UE with multiple control resource set pool index (CORESETPoolIndex) values on the serving cell.

3. The method of claim 1, wherein the first UE capability information message indicates support for single and/or multiple downlink reference timing values:
per UE;
per band;
per band combination;
per feature set (FS);
per feature set per component carrier (FSPC); or
per subcarrier spacing (SCS).

4. The method of claim 1, wherein the first UE capability information message indicates support for both the single downlink reference timing value and the multiple downlink reference timing values.

5. The method of claim 4, further comprising:
receiving a second control message configuring the UE for one of the single downlink reference timing value or the multiple downlink reference timing values.

6. The method of claim 5, wherein the second control message configures the UE:
per cell group;
per component carrier (CC); or
per bandwidth part (BWP) of a CC.

7. The method of claim 1, further comprising:
transmitting a second UE capability information message relating to support for one of a downlink reference timing difference between different TRPs of the plurality of TRPs within a threshold duration, or a downlink reference timing difference between different TRPs of the plurality of TRPs greater than a threshold duration.

8. The method of claim 7, wherein the second UE capability information message indicates support for one of the downlink reference timing difference within the threshold duration or the downlink reference timing difference greater than the threshold duration:
per UE;
per band;
per band combination;
per feature set (FS);
per feature set per component carrier (FSPC); or
per subcarrier spacing (SCS).

9. The method of claim 7, wherein the threshold duration is the duration of an orthogonal frequency division multiplexing (OFDM) cyclic prefix (CP).

10. The method of claim 7, further comprising:
determining a number of fast Fourier transforms (FFTs) to perform after downlink reception.

11. The method of claim 10, wherein determining the number of FFTs to perform is based on the downlink reference timing difference between different TRPs of the plurality of TRPs.

12. The method of claim 11, further comprising receiving a third control message indicating whether the downlink reference timing difference is greater than the threshold duration.

13. The method of claim 10, further comprising receiving a third control message indicating a number of FFTs to perform,
wherein determining the number of FFTs to perform is based on the third control message.

14. A method of wireless communication, comprising:
transmitting a first control message configuring a user equipment (UE) for multiple downlink control information (multi-DCI) based multiple transmit/receive point (multi-TRP) communication corresponding to a plurality of TRPs;
receiving a first UE capability information message relating to UE support for utilizing at least one of a single downlink reference timing value corresponding to a first TRP of the plurality of TRPs, or multiple downlink reference timing values corresponding to the plurality of TRPs; and
communicating with the UE with the single downlink reference timing value or with the multiple downlink reference timing values based on the first UE capability information message.

15. The method of claim 14, wherein the first control message configures the UE with multiple control resource set pool index (CORESETPoolIndex) values on the serving cell.

16. The method of claim 14, wherein the first UE capability information message indicates support for single and/or multiple downlink reference timing values:
per UE;
per band;
per band combination;
per feature set (FS);
per feature set per component carrier (FSPC); or
per subcarrier spacing (SCS).

17. The method of claim 14, wherein the first UE capability information message indicates support for both the single downlink reference timing value and the multiple downlink reference timing values.

18. The method of claim 14, further comprising:
transmitting, in response to the first UE capability information message, a second control message configuring the UE for one of the single downlink reference timing value or the multiple downlink reference timing values.

19. The method of claim 18, wherein the second control message configures the UE:
per cell group;
per component carrier (CC); or
per bandwidth part (BWP) of a CC.

20. The method of claim 14, further comprising:
receiving a second UE capability information message relating to support for a downlink reference timing difference between different TRPs of the plurality of TRPs greater than a threshold duration.

21. The method of claim 20, wherein the second UE capability information message indicates support for one of the downlink reference timing difference within the threshold duration or the downlink reference timing difference greater than the threshold duration:
per UE;
per band;
per band combination;
per feature set (FS);
per feature set per component carrier (FSPC); or
per subcarrier spacing (SCS).

22. The method of claim 20, wherein the threshold duration is the duration of an orthogonal frequency division multiplexing (OFDM) cyclic prefix (CP).

23. The method of claim 20, further comprising transmitting a third control message indicating whether the difference in the downlink reference timing values is greater than the threshold duration.

24. An apparatus for wireless communication, comprising:
a memory to store instructions; and
a processor coupled to the memory and configured to execute the instructions, the instructions comprising code for causing the apparatus to:
receive a first control message configuring a user equipment (UE) for multiple downlink control information (multi-DCI) based multiple transmit/receive point (multi-TRP) communication corresponding to a plurality of TRPs;
transmit a first UE capability information message relating to UE support for utilizing at least one of a single downlink reference timing value corresponding to a first TRP of the plurality of TRPs, or multiple downlink reference timing values corresponding to the plurality of TRPs; and
communicate with a serving cell with the single downlink reference timing value or with the multiple downlink reference timing values.

25. The apparatus of claim 24, wherein the first UE capability information message indicates support for both the single downlink reference timing value and the multiple downlink reference timing values.

26. The apparatus of claim 25, further comprising:
receiving a second control message configuring the UE for one of the single downlink reference timing value or the multiple downlink reference timing values.

27. The apparatus of claim 24, wherein the instructions further comprise code for causing the apparatus to:
transmit a second UE capability information message relating to support for one of a downlink reference timing difference between different TRPs of the plurality of TRPs within a threshold duration, or a downlink reference timing difference between different TRPs of the plurality of TRPs greater than a threshold duration.

28. The apparatus of claim 27, wherein the instructions further comprise code for causing the apparatus to:
determine a number of fast Fourier transforms (FFTs) to perform after downlink reception.

29. The apparatus of claim 28, wherein the code for causing the apparatus to determine the number of FFTs to perform is based on a downlink reference timing difference between different TRPs of the plurality of TRPs.

30. An apparatus for wireless communication, comprising:
a memory to store instructions; and
a processor coupled to the memory and configured to execute the instructions, the instructions comprising code for causing the apparatus to:
transmit a first control message configuring a user equipment (UE) for multiple downlink control information (multi-DCI) based multiple transmit/receive point (multi-TRP) communication corresponding to a plurality of TRPs;
receive a first UE capability information message relating to UE support for utilizing at least one of a single downlink reference timing value corresponding to a first TRP of the plurality of TRPs, or multiple downlink reference timing values corresponding to the plurality of TRPs; and
communicate with the UE with the single downlink reference timing value or with the multiple downlink reference timing values based on the first UE capability information message.
